(19) United States
(12) Patent Application Publication
(10) Pub. No.: US 2025/0291309 A1
(43) Pub. Date: Sep. 18, 2025

(54) IMAGE FORMING APPARATUS

(71) Applicant: CANON KABUSHIKI KAISHA, Tokyo (JP)

(72) Inventor: YOJI MISAO, Shizuoka (JP)

(21) Appl. No.: 19/076,184

(22) Filed: Mar. 11, 2025

(30) Foreign Application Priority Data
Mar. 12, 2024 (JP) 2024-037975

(51) Int. Cl. G03G 21/18; G03G 21/16

(52) U.S. Cl. CPC G03G 21/1821; G03G 21/1633; G03G 21/1647; G03G 21/1814; G03G 21/1846; G03G 2221/1675; G03G 2221/1853

(57) ABSTRACT

An image forming apparatus includes an apparatus main body, a first unit configured to be attached to the apparatus main body, a second unit configured to be attached to the apparatus main body and configured (1) to be drawn out from the apparatus main body together with the first unit and (2) to be drawn out from the apparatus main body while the first unit is accommodated in the apparatus main body, and a restriction structure configured to restrict the first unit from being drawn out from the apparatus main body in a case where the second unit is drawn out from the apparatus main body while the first unit is accommodated in the apparatus main body.

### BACKGROUND

### Technical Field

The present disclosure relates to an image forming apparatus.

### Description of the Related Art

In image forming apparatuses such as printers, copying machines, and P multifunctional machines, cartridges are detachable from a tray that can be drawn out from the inside to the outside of an apparatus main body.

Japanese Patent Application Publication No. 2010-244018 describes an image forming apparatus including a tray from which a cartridge is detachable and a fixing device. In the image forming apparatus, the tray can be drawn out from the inside to the outside of an apparatus main body of the image forming apparatus through a plurality of openings.

In addition, Japanese Patent Application Publication No. 2015-206897 describes an image forming apparatus including a tray from which a cartridge is detachable, a transfer unit, and a fixing device. In the image forming apparatus, the tray and the transfer unit can be drawn out from the inside to the outside of the image forming apparatus. In Japanese Patent Application Publication No. 2015-206897, the fixing device is disposed on one end side of the apparatus main body of the image forming apparatus, and when the transfer unit is drawn out from the inside to the outside of the apparatus main body, the transfer unit moves toward one end side from the other end side of the apparatus main body. On the other hand, when the tray is drawn out from the inside to the outside of the apparatus main body, the tray moves in a direction from one end side toward the other end side of the apparatus main body.

### SUMMARY

Some embodiments of the present disclosure provide a technology for further progress on an image forming apparatus in which such a plurality of units can be drawn out from an apparatus main body.

An aspect of the present disclosure is an image forming apparatus, including: an apparatus main body; a first unit configured to be attached to the apparatus main body; a second unit configured to be attached to the apparatus main body and configured (1) to be drawn out from the apparatus main body together with the first unit and (2) to be drawn out from the apparatus main body while the first unit is accommodated in the apparatus main body; and a restriction structure configured to restrict the first unit from being drawn out from the apparatus main body in a case where the second unit is drawn out from the apparatus main body while the first unit is accommodated in the apparatus main body, wherein during at least part of a process in which the first unit and the second unit are drawn out together from the apparatus main body, the second unit supports the first unit.

An aspect of the present disclosure is an image forming apparatus, including: an apparatus main body; a first unit configured to be attached to the apparatus main body; a second unit configured to be attached to the apparatus main body and configured (1) to be drawn out from the apparatus main body together with the first unit, and (2) to be drawn out from the apparatus main body while the first unit is accommodated in the apparatus main body; and a restriction structure configured to restrict the first unit from being drawn out from the apparatus main body in a case where the second unit is drawn out from the apparatus main body while the first unit is accommodated in the apparatus main body, wherein the first unit is an image forming unit including: a photosensitive drum; and a developing unit configured to form a toner image on a surface of the photosensitive drum, and wherein the second unit is a belt unit having a belt configured to come into contact with the photosensitive drum.

Further features of various embodiments of the present disclosure will become apparent from the following description of exemplary embodiments with reference to the attached drawings.

### BRIEF DESCRIPTION OF THE DRAWINGS

FIG. 1 is a diagram illustrating an overall configuration of an image forming apparatus in Example 1.

FIG. 2 is a diagram showing the image forming apparatus in Example 1 when a door is open.

FIG. 3 is a diagram showing the image forming apparatus in Example 1 when a fixing device is moved.

FIG. 4 is a diagram showing a state in which a transfer unit and a tray unit in Example 1 are drawn out.

FIG. 5 is a diagram showing a state in which the transfer unit in Example 1 is drawn out alone.

FIG. 6 is a diagram illustrating the movement of the transfer unit and the tray unit in Example 1.

FIG. 7 is a diagram illustrating the movement of the transfer unit and the tray unit in Example 1.

FIG. 8 is a diagram illustrating a connection mechanism between the tray unit and the transfer unit in Example 1.

FIG. 9 is a diagram illustrating the connection mechanism between the tray unit and the transfer unit in Example 1.

FIG. 10 is a diagram illustrating the connection mechanism between the tray unit and the transfer unit in Example 1.

FIG. 11A to FIG. 11D are diagrams illustrating a tray unit in a modification example.

FIG. 12 is a diagram illustrating a restriction member in Example 1.

FIG. 13A is a diagram illustrating a restriction structure in Example 1.

FIG. 13B is a diagram illustrating the restriction structure in Example 1.

FIG. 13C is a diagram illustrating the restriction structure in Example 1.

FIG. 14 is a diagram illustrating the restriction member and the transfer unit in Example 1.

FIG. 15 is a diagram showing a state in which a transfer unit in Example 2 is drawn out alone.

FIG. 16A and FIG. 16B are diagrams illustrating a tray guide and a tray unit in Example 2.

FIG. 17 is a diagram illustrating the tray unit and the transfer unit in Example 2.

### DESCRIPTION OF THE EMBODIMENTS

Forms for implementing the present disclosure will be exemplified below in detail based on examples with reference to the drawings. However, sizes, materials, shapes and relative arrangements of components described in the examples should be appropriately changed depending on the configuration of devices to which the present disclosure is applied and various conditions. That is, the scope of the present disclosure is not limited to the following examples. In addition, in the present disclosure, “at least one of A and B” means “A, B, or, A and B.”

### Example 1

### Overall Configuration

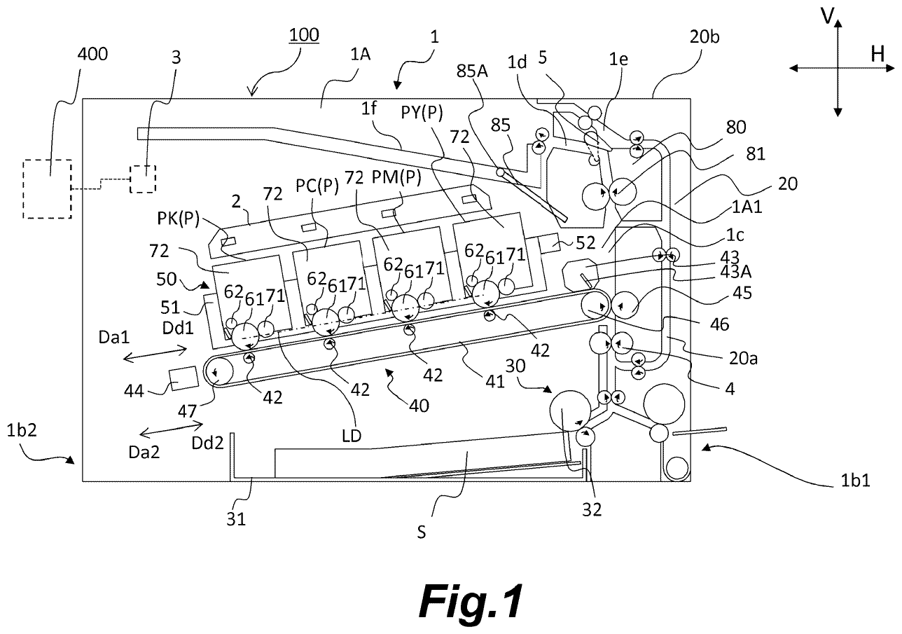

An image forming apparatus 1 in Example 1 will be described with reference to FIG. 1. FIG. 1 is a diagram illustrating an overall configuration of the image forming apparatus 1 in Example 1. In Example 1, the image forming apparatus 1 is an electrophotographic color laser beam printer that forms an image on a sheet S serving as a recording material.

The image forming apparatus 1 includes an apparatus main body (housing) 1A, a scanner (exposure device) 2, a control unit 3, and a door (opening/closing member) 20 that can be opened and closed with respect to the apparatus main body 1A. In addition, the image forming apparatus 1 includes a sheet feeding unit 30, a transfer unit (transfer device) 40, a tray unit (movement unit, support unit) 50, and a fixing device 80. The portion including the apparatus main body 1A and the door 20 can be called a main frame 100. The main frame 100 includes an exterior portion of the image forming apparatus 1.

The apparatus main body 1A accommodates the scanner 2, the control unit 3, the sheet feeding unit 30, the transfer unit 40, the tray unit 50, and the fixing device 80.

The sheet feeding unit 30 is a paper feeding unit that includes a stacking tray 31 on which sheets S serving as recording material are stacked and a supply roller 32, and supplies recording materials. The stacking tray 31 can be drawn out toward the door 20 to replenish the sheets S.

The tray unit 50 includes a tray (support member, drawer) 51 and cartridges PY, PM, PC, and PK. The tray 51 has a tray handle 52. The cartridges PY, PM, PC, and PK are removably attached to the tray 51.

The cartridges PY, PM, PC, and PK each are independently detachable from the tray 51. The cartridges PY, PM, PC, and PK each have a toner container 72 for accommodating toners (developers) of respective colors, yellow (Y), magenta (M), cyan (C), and black (K). The cartridges PY, PM, PC, and PK have the same configuration except for the colors of toners that they accommodate. Therefore, the configuration and operation of any one of the cartridges PY, PM, PC, and PK will be described, and the other cartridges will not be described. In addition, when there is no need to distinguish the cartridges PY, PM, PC, and PK, the cartridges PY, PM, PC, and PK may be simply described as a cartridge P. It can be said that the tray unit 50 includes a plurality of cartridges P and the tray 51 to which the plurality of cartridges P are removably attached.

In Example 1, the tray unit 50 includes a plurality of photosensitive drums (image bearing members) 61, a plurality of charging rollers 62 (charging members), and a plurality of developing rollers (developer bearing members) 71. Specifically, the tray unit 50 includes four photosensitive drums 61, four charging rollers 62, and four developing rollers 71. The rotation axis direction of the photosensitive drum 61, the rotation axis direction of the developing roller 71, and the rotation axis direction of the charging roller 62 are parallel to each other. The developing roller 71 is a developing unit that forms a toner image on the surface of the photosensitive drum 61.

The portion on which a black (K) image is formed is called a black station (first station), the photosensitive drum 61 of the first station is called a first photosensitive drum, the developing roller 71 is called a first developing roller, and the charging roller 62 is called a first charging roller.

The portion on which a cyan (C) image is formed is called a cyan station (second station), the photosensitive drum 61 of the second station is called a second photosensitive drum, the developing roller 71 is called a second developing roller, and the charging roller 62 is called a second charging roller.

The portion on which a magenta (M) image is formed is called a magenta station (third station), the photosensitive drum 61 of the third station is called a third photosensitive drum, the developing roller 71 is called a third developing roller, and the charging roller 62 is called a third charging roller.

The portion on which a yellow (Y) image is formed is called a yellow station (fourth station), the photosensitive drum 61 of the fourth station is called a fourth photosensitive drum, the developing roller 71 is called a fourth developing roller, and the charging roller 62 is called a fourth charging roller.

The cartridge PK is detachably attached to the black station, the cartridge PC is detachably attached to the cyan station, the cartridge PM is detachably attached to the magenta station, and the cartridge PY is detachably attached to the yellow station. In Example 1, the cartridge PK is called a first cartridge, the cartridge PC is called a second cartridge, the cartridge PM is called a third cartridge, and the cartridge PY is called a fourth cartridge.

Here, the numbers first, second, third, and fourth are used for convenience of explanation.

The photosensitive drum 61, the charging roller 62, and the developing roller 71 may be provided in either the cartridge P or the tray 51. In Example 1, the cartridge P includes the photosensitive drum 61, the charging roller 62, and the developing roller 71.

The transfer unit 40 includes a belt 41, a primary transfer roller 42, a cleaning unit 43, a drive roller 46 that drives the belt 41, and a tension roller (driven roller) 47. The transfer unit 40 is a belt unit having a belt that can come into contact with the photosensitive drum 61. In the image forming apparatus 1 in Example 1, an optical sensor 44 that detects a toner image transferred to the belt 41 is disposed. In Example 1, the belt 41 is disposed below the photosensitive drum 61 and can come into contact with the photosensitive drum 61 so that a primary transfer unit is formed between the belt 41 and the photosensitive drum 61. In addition, the image forming apparatus 1 includes a secondary transfer roller 45 that comes into contact with the belt 41 so that a secondary transfer unit is formed. The secondary transfer unit is formed between the belt 41 and the secondary transfer roller 45. The rotation axis direction of the primary transfer roller 42, the rotation axis direction of the drive roller 46, the rotation axis direction of the tension roller 47, and the rotation axis direction of the secondary transfer roller 45 are parallel to each other. A pair of registration rollers 4 are disposed in front of the secondary transfer unit.

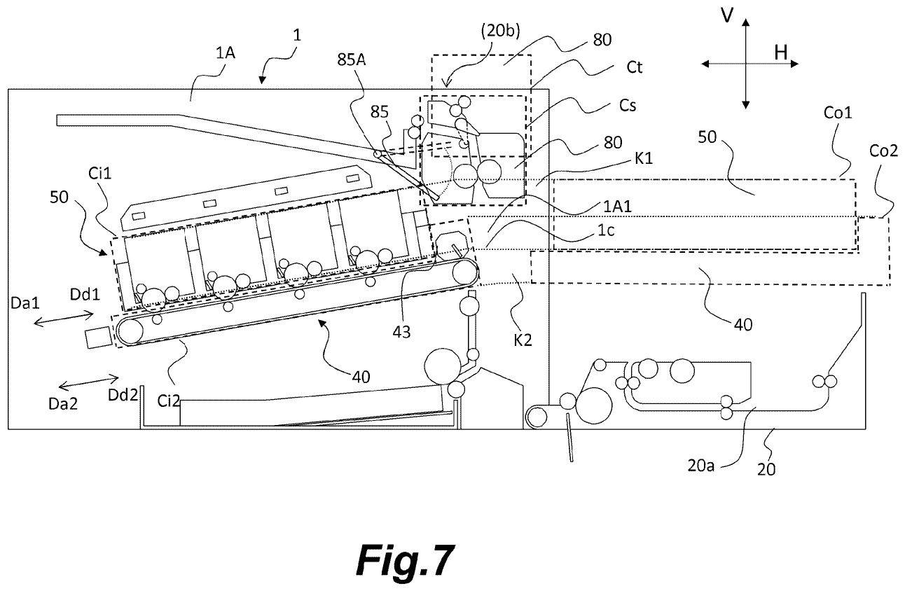

The fixing device 80 includes a fixing unit 81 and a flapper 5. When an image forming operation is performed on the sheet S, the fixing device 80 is at a use position Cs (refer to FIG. 7) at which a fixing operation for fixing the toner image transferred onto the recording material can be performed. The fixing device 80 is housed inside (in the inner side of) the apparatus main body 1A when it is at the use position Cs. In addition, the fixing device 80 is configured to heat the sheet S when it is at the use position Cs. In Example 1, the fixing unit 81 includes a heating unit (heating roller) including a heater and a pressing unit (pressing roller).

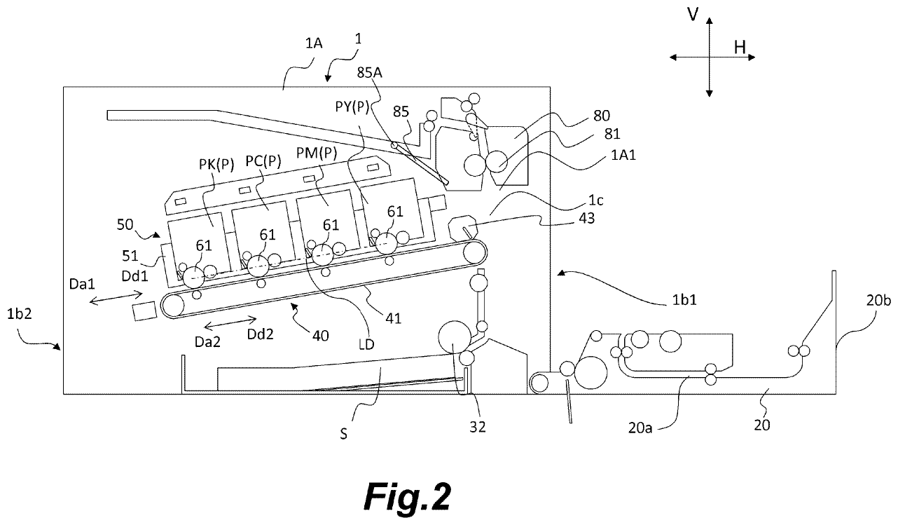

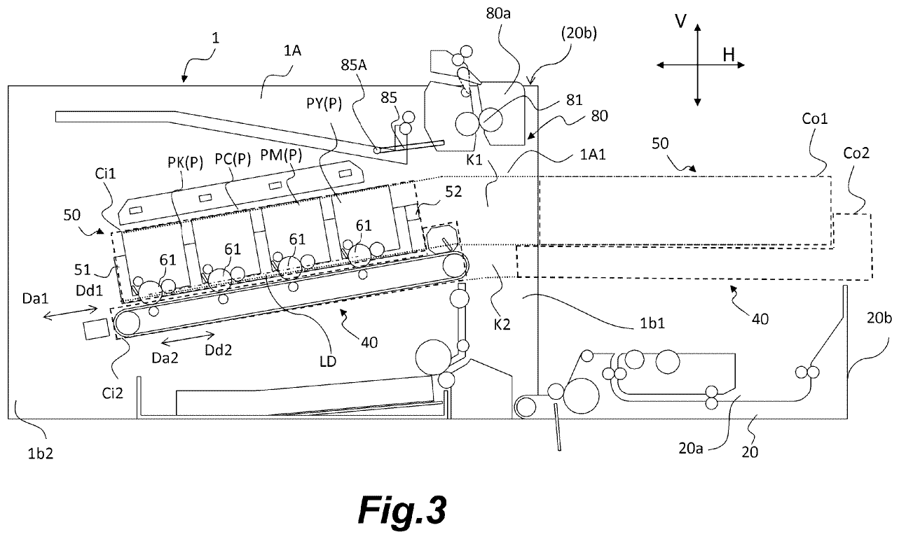

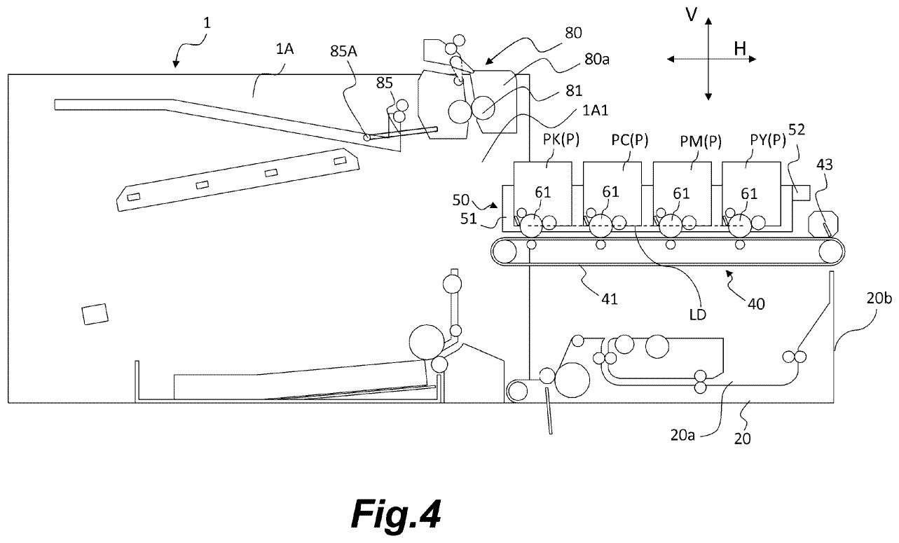

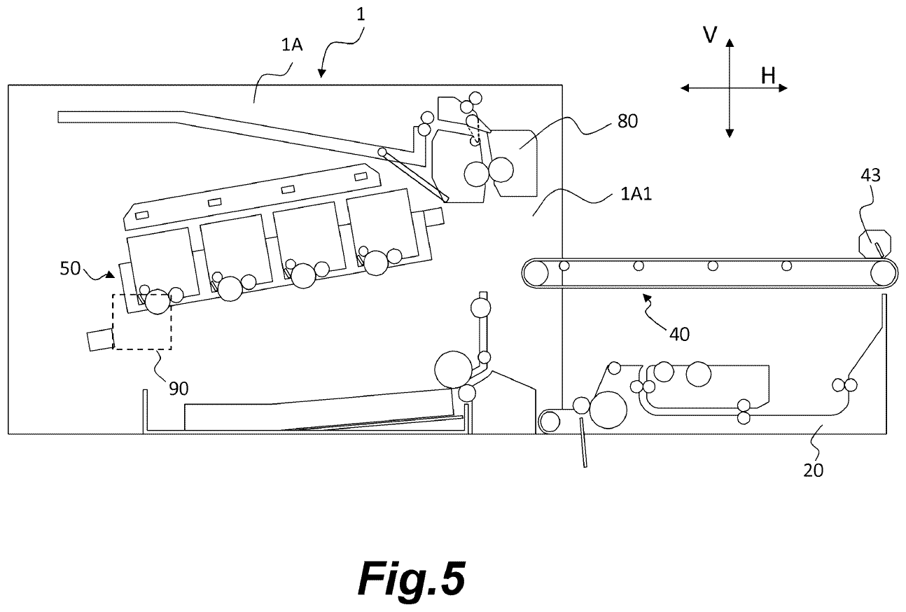

The movement of the transfer unit 40 and the tray unit 50 will be described with reference to FIG. 1, FIG. 2, FIG. 3, FIG. 4, and FIG. 5. FIG. 2 is a diagram showing the image forming apparatus 1 when the door 20 is open. FIG. 3 is a diagram showing the image forming apparatus 1 when the fixing device 80 is moved. FIG. 4 is a diagram showing the image forming apparatus 1 when the transfer unit 40 and the tray unit 50 are drawn out. FIG. 5 is a diagram showing the image forming apparatus 1 when the transfer unit 40 is drawn out alone.

The transfer unit 40 and the tray unit 50 are movable from the inside to the outside of the apparatus main body 1A. In a horizontal direction H, the apparatus main body 1A includes a first end 1b1 at which an opening 1A1 is provided and a second end 1b2 opposite to the first end 1b1. The tray unit 50 is movable through the opening 1A1 to a first inner position Ci1 inside the apparatus main body 1A and a first outer position Co1 outside the apparatus main body 1A. The transfer unit 40 is movable through the opening 1A1 to a second inner position Ci2 inside the apparatus main body 1A and a second outer position Co2 outside the apparatus main body 1A. The opening 1A1 may include an opening through which the tray unit 50 passes and an opening through which the transfer unit 40 passes. Here, when the transfer unit 40 moves from the second inner position Ci2 to the second outer position Co2, at least the belt 41 is moved, and at least a portion of the belt 41 protrudes from the apparatus main body 1A toward the outside of the apparatus main body 1A.

The direction in which the tray unit 50 moves from the first inner position Ci1 to the first outer position Co1 is called a tray removal direction Dd1, and the direction opposite to the tray removal direction Dd1 is called a tray attachment direction Da1. The tray removal direction Dd1 can be said to be the direction from the second end 1b2 to the first end 1b1.

The direction in which the transfer unit 40 moves from the second inner position Ci2 to the second outer position Co2 is called a transfer removal direction Dd2. The direction opposite to the transfer removal direction Dd2 is called a transfer attachment direction Da2. In the transfer removal direction Dd2, the drive roller 46 is positioned downstream from the tension roller 47. The transfer removal direction Dd2 can be said to be the direction from the second end 1b2 to the first end 1b1.

The tray removal direction Dd1 and the tray attachment direction Da1 are directions intersecting (preferably directions perpendicular to) the rotation axis direction of the photosensitive drum 61. The transfer removal direction Dd2 and the transfer attachment direction Da2 are directions intersecting (preferably directions perpendicular to) the rotation axis direction of the drive roller 46. The rotation axis direction of the drive roller 46 is parallel to the rotation axis direction of the photosensitive drum 61.

In the horizontal direction H, the fixing device 80 is disposed on one end side (the side on which the first end 1b1 is disposed) of the apparatus main body 1A.

The door 20 attached to the apparatus main body 1A is movable between a closed position and an open position. As shown in FIG. 1, when the door 20 is at the closed position (when the door 20 is closed), the door 20 covers the opening 1A1. As shown in FIG. 2, when the door 20 is at the open position (when the door 20 is open), the opening 1A1 is exposed.

As shown in FIG. 1, when the door 20 is at the closed position, the door 20 covers the fixing device 80 attached to the apparatus main body 1A. More specifically, when the door 20 is at the closed position, an upper cover 20b of the door 20 is positioned above the fixing device 80. The upper cover 20b of the door 20 functions as a part of the exterior portion.

When the fixing device 80 is supported by the apparatus main body 1A, the door 20 can move between the open position and the closed position. In other words, the door 20 moves from the closed position to the open position so that it is separated from the fixing device 80 supported by the apparatus main body 1A. Therefore, as shown in FIG. 2, when the door 20 is at the open position, the door 20 is separated from the fixing device 80 supported by the apparatus main body 1A.

As will be described below, the fixing device 80 is movable from the state shown in FIG. 2 to the state shown in FIG. 3 so that the opening 1A1 is widely exposed. When the door 20 and the fixing device 80 are moved (FIG. 3), the transfer unit 40 and the tray unit 50 are movable from the inside to the outside of the apparatus main body 1A through the opening 1A1 and are brought into the state shown in FIG. 4 after the movement.

When the tray unit 50 is moved to the outside of the apparatus main body 1A (FIG. 4), the cartridges PY, PM, PC, and PK can be removed from the tray 51 and the cartridges PY, PM, PC, and PK can be attached to the tray 51. Thereby, the cartridges PY, PM, PC, and PK can be replaced with new cartridges PY, PM, PC, and PK. In Example 1, the cartridge P is detachable from the tray 51 in a direction intersecting (preferably in a direction perpendicular to) the rotation axis of the photosensitive drum 61.

The cartridges PY, PM, PC, and PK are removed from the tray 51 by moving in a direction away from the transfer unit 40 relative to the tray 51. In other words, the cartridges PY, PM, PC, and PK are removed from the tray 51 by moving toward the side opposite to the transfer unit 40 relative to the tray 51. In Example 1, the transfer unit 40 is disposed below the tray unit 50. Therefore, the cartridges PY, PM, PC, and PK are moved upward relative to the tray 51 and removed from the tray 51.

In addition, the transfer unit 40 can be removed from the apparatus main body 1A independently of the tray unit 50 and can be replaced with a new transfer unit 40.

### Image Forming Operation

An image forming operation of the image forming apparatus 1 will be described with reference to FIG. 1. The control unit 3 of the image forming apparatus 1 starts an image forming operation on the sheet S based on an image signal received from an external host device 400. The external host device 400 is, for example, a personal computer, an image reader, a facsimile or the like.

When an image is formed on the sheet S, the fixing device 80 is positioned at the use position Cs, the tray unit 50 is positioned at the first inner position Ci1, the transfer unit 40 is positioned at the second inner position Ci2, and the door 20 is positioned at the closed position. When the transfer unit 40 is at the second inner position Ci2, the belt 41 can come into contact with the photosensitive drum 61. In this case, the tray unit 50 is positioned above the transfer unit 40.

A charge voltage is applied to the charging roller 62, and the photosensitive drum 61 rotates. A laser beam corresponding to image information is emitted from the scanner 2 to the photosensitive drum 61, and the surface of the photosensitive drum 61 charged by the charging roller 62 is exposed. Thereby, an electrostatic latent image corresponding to image information is formed on the surface of the photosensitive drum 61.

The developing roller 71 carriers a toner. A developing voltage is applied to the developing roller 71, the electrostatic latent image formed on the photosensitive drum 61 is developed with the toner supplied from the developing roller 71, and a toner image is formed on the surface of the photosensitive drum 61. In Example 1, the developing roller 71 develops the electrostatic latent image when it comes into contact with the photosensitive drum 61, but the developing roller 71 may develop an electrostatic latent image when there is a gap between the developing roller 71 and the photosensitive drum 61.

When a full-color image is formed, a toner image of each of the colors Y, M, C, and K is formed on each of the photosensitive drums 61.

Here, in Example 1, when the tray unit 50 is at the first inner position Ci1, the developing roller 71 is movable between a contact position where the developing roller 71 comes into contact with the photosensitive drum 61 and a separation position where the developing roller 71 is separated from the photosensitive drum 61. Specifically, a switching device provided in the apparatus main body 1A switches between a state in which the developing roller 71 is at the contact position and a state in which the developing roller 71 is at the separation position. Thereby, when no image forming operation is performed, the developing roller 71 can be separated from the photosensitive drum 61.

In addition, the image forming apparatus 1 can perform monochrome printing when the developing roller 71 corresponding to the cartridge PK comes into contact with the photosensitive drum 61, and the developing rollers 71 corresponding to the cartridges PY, PM, and PC are separated from the photosensitive drum 61. In addition, the image forming apparatus 1 can perform full-color printing when the photosensitive drums 61 corresponding to the cartridges PY, PM, PC, and PK come into contact with the belt 41.

The toner images formed on the photosensitive drums 61 are transferred onto the belt 41 by the primary transfer roller 42 in the primary transfer unit and conveyed toward the secondary transfer unit formed by the belt 41 and the secondary transfer roller 45.

On the other hand, in the apparatus main body 1A, a conveying path (first path, first conveying path) 1c through which the sheet S passes toward the fixing device 80 is formed. In addition, in the door 20, a double-sided conveying path (second path, second conveying path) 20a through which the sheet S that has passed through the fixing device 80 passes is formed. The door 20 in a closed state covers the conveying path 1c. When the door 20 is open, the conveying path 1c and the double-sided conveying path 20a are exposed (FIG. 2).

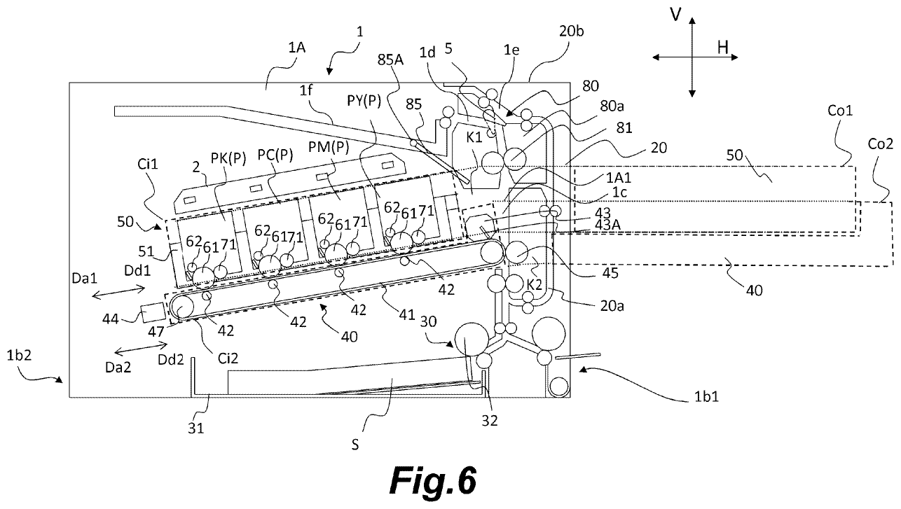

The secondary transfer roller 45, the pair of registration rollers 4, the conveying path 1c, the double-sided conveying path 20a and the like constitute a conveying unit that conveys a recording material. The conveying path 1c, which is a part of the conveying unit, one roller of the pair of registration rollers 4, and the double-sided conveying path 20a are movable between a first position shown in FIG. 1 and a second position shown in FIG. 2 in connection with the opening and closing of the door 20. When the door 20 is closed, the conveying unit moves to the first position, and when the door 20 is open, the conveying unit moves to the second position. As shown in FIG. 6, the space through which the tray unit 50 passes when it is drawn out from the apparatus main body 1A is defined as a first space K1, and the space through which the transfer unit 40 passes when it is drawn out from the apparatus main body 1A is defined as a second space K2. In this case, as shown in FIG. 6, at the first position, at least a portion of the conveying unit is positioned inside at least one of the first space K1 and the second space K2. In addition, as shown in FIG. 3, at the second position, the conveying unit is positioned outside the first space K1 and the second space K2.

In the sheet feeding unit 30, at a predetermined timing, one sheet S is separated and fed by the supply roller 32 from the sheets S stacked on the stacking tray 31, and conveyed through the conveying path 1c toward the secondary transfer unit and the fixing device 80.

In the secondary transfer unit, the toner image is transferred from the belt 41 to the sheet S. The toner that has not been transferred to the sheet S is removed from the belt 41 by a cleaning blade (cleaning member) 43A provided in the cleaning unit 43.

In the secondary transfer unit, the sheet S onto which the toner image is transferred is conveyed toward the fixing device 80. In the fixing device 80, the sheet S is heated and pressed by the fixing unit 81, and the toner image is fixed onto the sheet S. The sheet S onto which the toner image is fixed is conveyed toward the flapper 5 serving as a path switching unit.

The flapper 5 is movable between a discharge position for guiding the sheet S that has passed through the fixing device 80 toward a discharge path 1d and an inversion position for guiding the sheet S toward an inversion path 1e.

When single-sided printing in which an image is formed on one surface of the sheet S is performed, the sheet S is guided to the discharge path 1d by the flapper 5, and discharged to a discharge tray 1f formed on the upper part of the apparatus main body 1A.

On the other hand, when double-sided printing in which an image is printed on one surface and the back surface of the sheet S is performed, the sheet S is guided to the inversion path 1e by the flapper 5. After the sheet S is guided to the inversion path 1e, the conveying direction of the sheet S is reversed, and the sheet S passes through the double-sided conveying path 20a formed in the door 20, and is conveyed toward the secondary transfer unit. In the secondary transfer unit, after the toner image is transferred onto the back surface of the sheet S, the sheet S passes through the fixing device 80, and is guided to the discharge path 1d by the flapper 5, and discharged to the discharge tray 1f of the apparatus main body 1A.

### Removal of Tray Unit and Transfer Unit, and Disposition of Fixing Device

The removal of the tray unit 50 and the transfer unit 40 from the apparatus main body 1A and the disposition of the fixing device 80 will be described with reference to FIG. 1, FIG. 2, FIG. 3, FIG. 4, and FIG. 5.

As described above, the fixing device 80 of the image forming apparatus 1 is disposed on one end side of the apparatus main body 1A in the horizontal direction H. In addition, the transfer unit 40 and the tray unit 50 move from one end side of the apparatus main body 1A to the outside of the apparatus main body 1A through the opening 1A1.

In other words, in the horizontal direction H, the fixing device 80 is closer to the first end 1b1 than to the second end 1b2. That is, in the horizontal direction H, the distance between the fixing device 80 and the first end 1b1 is shorter than the distance between the fixing device 80 and the second end 1b2. It can be said that the fixing device 80 is disposed at a position closer to the first end 1b1 than the center of the apparatus main body 1A is to the first end 1b1 in the horizontal direction H, and the distance between the first end 1b1 and the fixing device 80 in the horizontal direction H is shorter than the distance between the first end 1b1 and the center of the apparatus main body 1A.

In addition, as described above, when the tray unit 50 moves from the first inner position Ci1 to the first outer position Co1, the movement direction of the tray unit 50 is a direction intersecting the rotation axis of the photosensitive drum 61. In this case, the tray unit 50 moves away from the second end 1b2.

As described above, when the transfer unit 40 moves from the second inner position Ci2 to the second outer position Co2, the movement direction of the transfer unit 40 is a direction intersecting the rotation axis of the drive roller 46. In this case, the transfer unit 40 moves away from the second end 1b2.

As described above, in Example 1, the door 20 in a closed state covers the opening 1A1, and covers at least a portion of the conveying path 1c for the sheet S. In addition, the door 20 includes the double-sided conveying path 20a. When a sheet S becomes jammed (hereinafter referred to as a jam), a user of the image forming apparatus 1 can remove the sheet S from one end side of the apparatus main body 1A and eliminate the jam. Specifically, the user can move the door 20 to the open position, access the inside of the apparatus main body 1A, and remove the sheet S. In addition, when a part of the sheet S that has passed through the fixing device 80 is exposed to the outside of the apparatus main body 1A, the sheet S can be removed by pulling the sheet S from the outside of the apparatus main body 1A without opening the door 20.

In addition, the user of the image forming apparatus 1 can move the transfer unit 40 and the tray unit 50 from one end side of the apparatus main body 1A to the outside of the apparatus main body 1A, and perform operations such as checking the state, maintenance, and replacement of the transfer unit 40 and the cartridge P.

That is, in the image forming apparatus 1, the fixing device 80 is disposed on one end side of the apparatus main body 1A, and the transfer unit 40 and the tray unit 50 are movable inside and outside the apparatus main body 1A through one end side of the apparatus main body 1A. As a result, the user can eliminate jams, access the fixing device 80, and perform an operation of the transfer unit 40 and the tray unit 50 in one direction.

In Example 1, the side of the door 20 is the front side of the image forming apparatus 1. Therefore, it is sufficient to secure a space around the image forming apparatus 1 in order to eliminate jams and perform operations such as operating the transfer unit 40 and the tray unit 50 from the front side of the image forming apparatus 1. On the other hand, there is no need to secure the space for performing these operations from the left side, the right side, the rear side, and the upper side of the image forming apparatus 1. Therefore, the image forming apparatus 1 can be installed in a small space.

When the transfer unit 40 or the tray unit 50 is drawn out from the other end side of the apparatus main body 1A, the user needs to access both end sides of the apparatus main body 1A in order to eliminate jams and draw out the transfer unit 40 or the tray unit 50. In addition, when one of the transfer unit 40 and the tray unit 50 is drawn out from one end side of the apparatus main body 1A, and the other of the transfer unit 40 and the tray unit 50 is drawn out from the other end side, the user needs to access both end sides of the apparatus main body 1A. Therefore, a space for operating not only the front side but also the rear side of the apparatus main body 1A is required, and the area required for installing the image forming apparatus 1 increases.

In addition, in Example 1, the sheet S can be replenished from one end side of the apparatus main body 1A. Therefore, it is only necessary to secure a space for replenishing the sheet S from the front side of the image forming apparatus 1, and the image forming apparatus 1 can be installed in a small space.

### Movement Mechanism of Fixing Device

The relationship between the tray unit 50 and the fixing device 80 will be described with reference to FIG. 1, FIG. 2, FIG. 3, FIG. 4, FIG. 6, and FIG. 7. FIG. 6 and FIG. 7 are diagrams illustrating the movement of the transfer unit 40 and the tray unit 50.

The tray unit 50 passes through a predetermined space when it moves between the first inner position Ci1 at which an image forming operation is performed on the sheet S and the first outer position Co1 at which the replacement of the cartridge P is allowed. In this manner, the space through which the tray unit 50 passes when it moves from the first inner position Ci1 to the first outer position Co1 is called the first space K1 (movement space of the tray unit 50). The first space K1 can also be called a path or trajectory (first movement path, first movement trajectory) through which the tray unit 50 passes when it moves from the first inner position Ci1 to the first outer position Co1.

The transfer unit 40 passes through a predetermined space when it moves between the second inner position Ci2 at which an image forming operation is performed on the sheet S and the second outer position Co2. In this manner, the space through which the transfer unit 40 passes when it moves from the second inner position Ci2 to the second outer position Co2 is called the second space K2 (movement space of the transfer unit 40). The second space K2 can also be called a path or trajectory (second movement path, second movement trajectory) through which the transfer unit 40 passes when it moves from the second inner position Ci2 to the second outer position Co2.

The position (the use position Cs) of the fixing device 80 when an image forming operation is performed on the sheet S, the first space K1 and the second space K2 have the following relationship.

That is, as shown in FIG. 6 and FIG. 7, at least a portion of the fixing device 80 at the use position Cs overlaps the first space K1. In other words, when the fixing device 80 is at the use position Cs, at least a portion of the fixing device 80 is positioned inside the first space K1.

In Example 1, at least a portion of the fixing device 80 overlaps the space through which the cartridge P passes when the tray unit 50 moves from the first inner position Ci1 to the first outer position Co1, but it may be disposed to overlap the space through which the tray 51 passes.

Thereby, compared to a configuration in which the fixing device 80 at the use position Cs is positioned outside the first space K1, the size of the apparatus main body 1A can be reduced.

Here, as shown in FIG. 6, in Example 1, when the door 20 is closed, at least a portion of the double-sided conveying path 20a overlaps the first space K1. That is, when the door 20 is closed, at least a portion of the double-sided conveying path 20a is positioned inside the first space K1.

As described above, at least a portion of the fixing device 80 at the use position Cs is positioned inside the first space K1. Therefore, when the fixing device 80 is at the use position Cs, the tray unit 50 is restricted from moving from the first inner position Ci1 to the first outer position Co1. On the other hand, the fixing device 80 is movable between the use position Cs and a retraction position Ct at which retraction occurs from the use position Cs. When the fixing device 80 moves from the use position Cs to the retraction position Ct, the tray unit 50 is allowed to move from the first inner position Ci1 to the first outer position Co1. When the tray unit 50 moves from the first inner position Ci1 to the first outer position Co1, the tray unit 50 passes below the fixing device 80. Here, the fixing device 80 is positioned outside the second space K2 at the use position Cs and the retraction position Ct. Therefore, in both the state in which the fixing device 80 is at the use position Cs and the state in which the fixing device 80 is at the retraction position Ct, the transfer unit 40 can move from the second inner position Ci2 to the second outer position Co2. When the transfer unit 40 moves from the second inner position Ci2 to the second outer position Co2, the transfer unit 40 passes below the fixing device 80.

The fixing device 80 includes a fixing frame 80a that supports the fixing unit 81. When the fixing device 80 is retracted from the use position Cs, the fixing frame 80a that supports the fixing unit 81 is displaced relative to the apparatus main body 1A.

When the tray unit 50 is drawn out to the outside of the apparatus main body 1A, first, the door 20 is moved to the open position, as shown in FIG. 2. In Example 1, when the fixing device 80 is positioned at the use position Cs, the door 20 can be moved to the open position and the closed position. Then, when the door 20 is at the open position, as shown in FIG. 3, the fixing device 80 is moved from the use position Cs to the retraction position Ct so that it is moved outside of the first space K1.

In the image forming apparatus 1 in Example 1, the fixing device 80 is movable between the use position Cs and the retraction position Ct retracted from the use position Cs while attached to the apparatus main body 1A. In Example 1, when the fixing device 80 is at the retraction position Ct, the entire fixing device 80 is positioned outside of the first space K1.

Here, at the use position Cs, at least a portion of the fixing device 80 may be positioned inside the second space K2, and a portion of the fixing device 80 may be positioned inside the first space K1 and another portion may be positioned inside the second space K2.

The fixing device 80 can be lifted from the use position Cs and moved to the retraction position Ct above the use position Cs. In other words, the retraction position Ct is a position higher than the use position Cs. As shown in FIG. 7, when the fixing device 80 is at the retraction position Ct, at least a portion of the fixing device 80 is positioned at a position protruding from the apparatus main body 1A toward the outside of the apparatus main body 1A. In addition, when the fixing device 80 is at the retraction position Ct, the position of at least a portion of the fixing device 80 is higher than the position of the upper cover 20b of the door 20 at the closed position. Thereby, in a vertical direction V, by moving the fixing device 80 to the retraction position Ct while maintaining a small size of the image forming apparatus 1 when the fixing device 80 is at the use position Cs, it is possible to secure the space for movement of the tray unit 50. Here, when the fixing device 80 is at the retraction position Ct, the door 20 taking the closed position is restricted.

Specifically, the image forming apparatus 1 includes a connecting member (fixing connecting member, fixing link, arm) 85 that is movably connected to the apparatus main body 1A. The fixing device 80 is connected to the apparatus main body 1A via the connecting member 85.

The connecting member 85 is rotatable around a rotation center 85A, and when the tray unit 50 is drawn out to the outside of the apparatus main body 1A, the connecting member 85 is moved to the outside of the first space K1. The fixing device 80 is rotatably connected to one end of the connecting member 85, and the other end of the connecting member 85 is rotatably connected to the apparatus main body 1A around the rotation center 85A. The fixing device 80 that is supported by the connecting member 85 (that is connected to the apparatus main body 1A via the connecting member 85) is movable from the use position Cs to the retraction position Ct or movable from the retraction position Ct to the use position Cs. The connecting member 85 is configured to be movable (swingable) relative to the apparatus main body 1A and the fixing device 80. That is, the fixing device 80 is connected to the apparatus main body 1A via the connecting member 85. As a result, compared to a configuration in which the fixing device 80 is directly connected to the apparatus main body 1A, it is possible to increase the amount of movement of the fixing device 80 when the fixing device 80 moves between the retraction position Ct and the use position Cs.

As shown in FIG. 7, when the tray unit 50 moves from the first inner position Ci1 to the first outer position Co1, the angle between the movement direction Dd1 of the tray unit 50 and the horizontal direction H is smaller than the angle between the movement direction Dd1 of the tray unit 50 and the vertical direction V. In addition, when the fixing device 80 moves from the use position Cs to the retraction position Ct, the amount of movement of the fixing device 80 in the vertical direction V is larger than the amount of movement of the fixing device 80 in the horizontal direction H. That is, when the fixing device 80 moves from the use position Cs to the retraction position Ct, the amount of movement of the fixing device 80 in a direction perpendicular to the movement direction Dd1 of the tray unit 50 is larger than the amount of movement of the fixing device 80 in a direction parallel to the movement direction Dd1 of the tray unit 50.

In addition, the fixing device 80 that is attached to the apparatus main body 1A via a guide fixed to the apparatus main body 1A is movable between the use position Cs and the retraction position Ct. In this case, the shape of the guide is arbitrary.

However, the method for moving the fixing device 80 to the outside of the first space K1 is not limited thereto. For example, the fixing device 80 can be removed from the apparatus main body 1A so that it retracts from the use position Cs, and the fixing device 80 may be moved to the outside of the first space K1. That is, when the fixing device 80 is separated from the apparatus main body 1A and the door 20 (separated from the main frame 100), the fixing device 80 may be positioned to the outside of the first space K1. In addition, when the fixing device 80 is connected to the door 20, and the door 20 is open, the fixing device 80 may be moved to the outside of the first space K1.

### Relationship Between Tray Unit and Transfer Unit

The relationship between the tray unit 50 and the transfer unit 40 will be described with reference to FIG. 1, FIG. 2, FIG. 3, FIG. 4, FIG. 5, FIG. 6, and FIG. 7.

As shown in FIG. 3, when the fixing device 80 is positioned outside the first space K1, the user grips the tray handle 52 and moves the tray unit 50 toward the outside of the apparatus main body 1A.

As shown in FIG. 6 and FIG. 7, when an image forming operation is performed on the sheet S, the position of the transfer unit 40 and the first space K1 have the following relationship.

That is, when an image forming operation is performed on the sheet S, the transfer unit 40 is at the second inner position Ci2. As shown in FIG. 6 and FIG. 7, at least a portion of the transfer unit 40 at the second inner position Ci2 overlaps the first space K1. In other words, when the transfer unit 40 is at the second inner position Ci2, at least a portion of the transfer unit 40 is positioned inside the first space K1.

In Example 1, when the tray unit 50 moves from the first inner position Ci1 to the first outer position Co1, at least a portion of the transfer unit 40 overlaps the space through which the tray 51 passes, but it may be disposed to overlap the space through which the cartridge P passes.

Thereby, compared to a configuration in which the transfer unit 40 at the second inner position Ci2 is positioned outside the first space K1, the size of the apparatus main body 1A can be reduced.

Here, in the image forming apparatus 1 in Example 1, a part of the transfer unit 40 overlapping the first space K1 is the cleaning unit 43 that accommodates the cleaning member 43A. However, the other part of the transfer unit 40 may overlap the first space K1. In addition, in Example 1, the cleaning member 43A of the transfer unit 40 at the second inner position Ci2 overlaps the first space K1.

It can be said that the tray unit 50 and the transfer unit 40 have the following relationship. A state in which the tray unit 50 is at the first inner position Ci1 and the transfer unit 40 is at the second inner position Ci2 is considered. In this state, in the movement direction in which the tray unit 50 moves from the first inner position Ci1 to the first outer position Co1, a part (the cleaning unit 43) of the transfer unit 40 is positioned downstream from the tray unit 50. In addition, in the vertical direction V, an area (range) in which a part (the cleaning unit 43) of the transfer unit 40 downstream from the tray unit 50 is disposed at least partially overlaps an area (range) in which the tray unit 50 is disposed.

Here, in Example 1, when the door 20 is closed, at least a portion of the double-sided conveying path 20a overlaps the second space K2 through which the transfer unit 40 passes when it moves from the second inner position Ci2 to the second outer position Co2. That is, when the door 20 is closed, at least a portion of the double-sided conveying path 20a is positioned inside the second space K2.

As described above, when the transfer unit 40 is at the second inner position Ci2, at least a portion of the transfer unit 40 is positioned inside the first space K1. Therefore, in Example 1, when the user moves the tray unit 50 from the first inner position Ci1 to the first outer position Co1 relative to the apparatus main body 1A, the transfer unit 40 also moves to the second outer position Co2 from the second inner position Ci2 relative to the apparatus main body 1A. That is, when the transfer unit 40 and the tray unit 50 are integrated, the tray unit moves from the first inner position Ci1 to the first outer position Co1, and the transfer unit 40 moves from the second inner position Ci2 to the second outer position Co2.

When the tray unit 50 moves to the first outer position Co1 by moving the tray unit 50 and the transfer unit 40 together, it is possible to prevent the photosensitive drum 61 from being exposed and to prevent the photosensitive drum 61 from being scratched or stained.

As shown in FIG. 7, when the door 20 is open, the tray unit 50 is at the first outer position Co1, and the transfer unit 40 is at the second outer position Co2, the transfer unit 40 supports the tray unit 50 from below the tray unit 50. In addition, in Example 1, the door 20 supports the transfer unit 40. That is, the transfer unit 40 supported by the door 20 supports the tray unit 50. In this state, the door 20 can be said to support the tray unit 50 via the transfer unit 40.

### Connection Mechanism Between Tray Unit and Transfer Unit

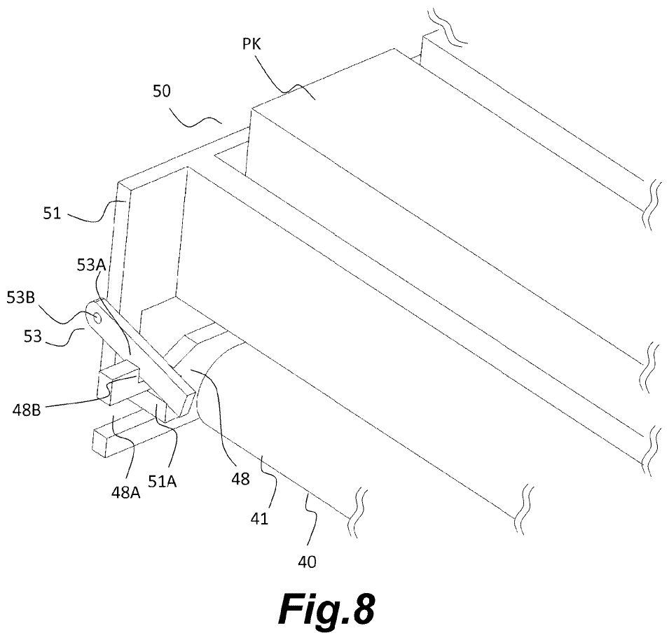

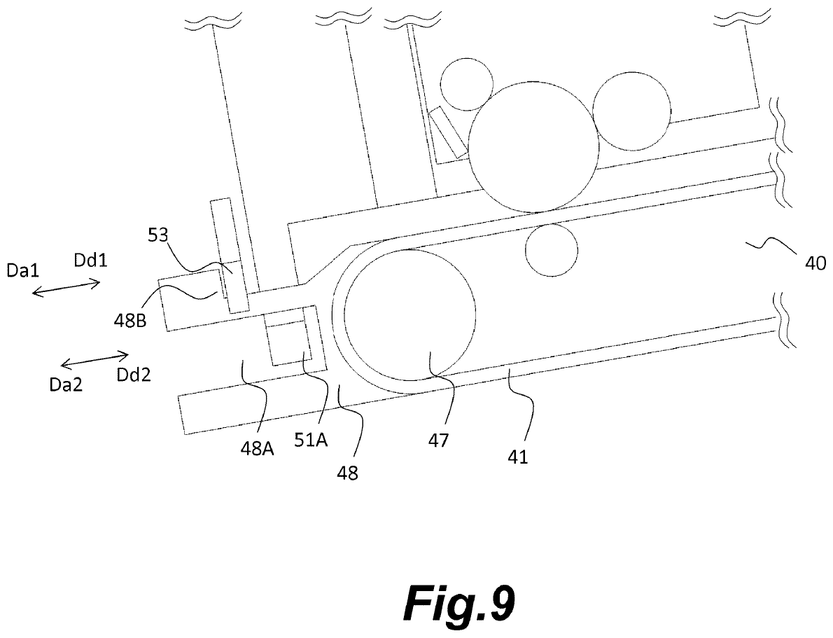

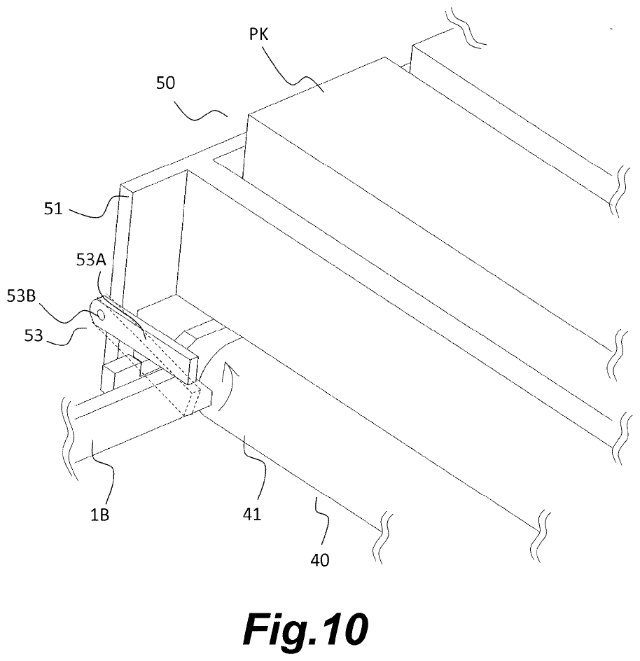

A configuration for moving the tray unit 50 and the transfer unit 40 together will be described with reference to FIG. 8, FIG. 9, and FIG. 10. FIG. 8, FIG. 9, and FIG. 10 are diagrams illustrating a locking member (lever, stopper, connecting member) 53 connecting the tray 51 of the tray unit 50 and the transfer unit 40.

The image forming apparatus 1 in Example 1 includes the locking member 53. In Example 1, the locking member 53 is provided in the tray 51 of the tray unit 50. The locking member 53 includes a transfer locking unit 53A and is rotatable around a rotation center 53B.

The tray 51 includes a transfer connecting unit 51A. The transfer unit 40 includes the drive roller 46, the tension roller 47, and a transfer frame 48 that supports the primary transfer roller 42. A tray connection groove 48A and a lock connecting unit 48B are provided in the transfer frame 48.

When the locking member 53 rotates around the rotation center 53B, the transfer locking unit 53A is engaged with the lock connecting unit 48B and is movable between a connection position at which the transfer unit 40 and the tray unit 50 are connected and a release position at which retraction occurs from the connection position.

When the transfer connecting unit 51A is engaged with the tray connection groove 48A, the tray unit 50 is restricted from moving in the tray removal direction Dd1 and a direction perpendicular to the tray removal direction Dd1 relative to the transfer unit 40. On the other hand, the transfer unit 40 is restricted from moving in the transfer attachment direction Da2 and a direction perpendicular to the transfer attachment direction Da2 relative to the tray unit 50.

Such a configuration is provided at a total of four locations: near both ends of the tension roller 47 in the rotation axis direction of the tension roller 47 and near both ends of the drive roller 46 in the rotation axis direction of the drive roller 46.

When the transfer locking unit 53A of the locking member 53 at the connection position is engaged with the lock connecting unit 48B, the tray unit 50 is restricted from moving in the tray attachment direction Da1 relative to the transfer unit 40. On the other hand, the transfer unit 40 is restricted from moving in the transfer removal direction Dd2 relative to the tray unit 50.

The locking member 53 and the lock connecting unit 48B may be provided at both ends of the transfer unit 40 in the rotation axis direction of the tension roller 47.

That is, when the transfer connecting unit 51A is engaged with the tray connection groove 48A and the locking member 53 at the connection position is engaged with the lock connecting unit 48B, the transfer unit 40 and the tray unit 50 are restricted from moving relative to each other. Here, in this state, there may be free mobility between the transfer unit 40 and the tray unit 50.

That is, it can be said that the transfer connecting unit 51A and the locking member 53 function as a tray-side connection device, and the tray connection groove 48A and the lock connecting unit 48B function as a transfer-side connection device. When the tray-side connection device and transfer-side connection device are connected, the tray unit 50 and the transfer unit 40 are connected, and the tray unit 50 and the transfer unit 40 move together.

On the other hand, as shown in FIG. 10, the apparatus main body 1A includes an unlocking unit 1B. When the tray unit 50 is at the first inner position Ci1 and the transfer unit 40 is at the second inner position Ci2, the locking member 53 comes into contact with the unlocking unit 1B and is at the release position. In this state, the transfer locking unit 53A is separated from the lock connecting unit 48B.

When the locking member 53 is at the release position, if the tray unit 50 is moved to the tray removal direction Dd1, the transfer unit 40 is pushed in the transfer removal direction Dd2 by the transfer connecting unit 51A provided in the tray 51. As a result, the transfer unit 40 is also moved in the transfer removal direction Dd2 together with the tray unit 50. When the tray unit 50 moves a predetermined distance in the tray removal direction Dd1, the locking member 53 is separated from the unlocking unit 1B, moves to the connection position, and is engaged with the lock connecting unit 48B. When the locking member 53 is at the connection position and engaged with the lock connecting unit 48B, the tray unit 50 is moved to the first outer position Co1 and the transfer unit 40 is moved to the second outer position Co2.

When the locking member 53 is engaged with the lock connecting unit 48B, if the tray unit 50 is moved to the tray attachment direction Da1, the transfer unit 40 is pushed in the transfer attachment direction Da2 by the locking member 53. As a result, the transfer unit 40 is also moved in the transfer attachment direction Da2 together with the tray unit 50.

When the locking member 53 is engaged with the lock connecting unit 48B, if the transfer unit 40 is moved in the transfer attachment direction Da2, the transfer unit 40 pushes the transfer connecting unit 51A and the tray unit 50 is pushed in the tray attachment direction Da1. As a result, the tray unit 50 is also moved in the tray attachment direction Da1 together with the transfer unit 40.

When the tray unit 50 and the transfer unit 40 are moved together inward the apparatus main body 1A, the locking member 53 is moved to the release position by the unlocking unit 1B. In this state, even if the tray unit 50 is moved in the tray attachment direction Da1, the transfer unit 40 does not move. Therefore, in the process of closing the door 20, due to a force with which the secondary transfer roller 45 comes into contact with the transfer unit 40, the transfer unit 40 is pushed in the transfer attachment direction Da2 and pushed to the rear of the apparatus main body 1A (the second inner position Ci2). That is, the door 20 can push the transfer unit 40 so that the transfer unit 40 moves to the second inner position Ci2. In addition, the door 20 may also push the tray unit 50 so that the tray unit 50 moves in the first inner position Ci1.

On the other hand, a state in which the locking member 53 is at the release position and the tray unit 50 is at the first inner position Ci1 is considered. In this state, when the transfer unit 40 is moved to the transfer removal direction Dd2, the transfer unit 40 can move from the second inner position Ci2 to the second outer position Co2 independently of the tray unit 50. In the image forming apparatus 1 in Example 1, as shown in FIG. 5, when the tray unit 50 is positioned inside the apparatus main body 1A (the first inner position Ci1), the transfer unit 40 can be moved to the outside of the apparatus main body 1A (the second outer position Co2). The transfer unit 40 can be removed from the apparatus main body 1A and can be replaced with a new transfer unit 40.

In Example 1, when the tray unit 50 is at the first inner position Ci1, the tray unit 50 is positioned relative to the apparatus main body 1A independently of the transfer unit 40. In addition, when the transfer unit 40 is at the second inner position Ci2, the transfer unit 40 is positioned relative to the apparatus main body 1A independently of the tray unit 50. This is because priority is given to accurately positioning the transfer unit 40 and the tray unit 50 relative to the apparatus main body 1A. Therefore, when the tray unit 50 is at the first inner position Ci1 and the transfer unit 40 is at the second inner position Ci2, a slight clearance is provided between the tray connection groove 48A and the transfer connecting unit 51A.

When the tray unit 50 is at the first inner position Ci1 and the transfer unit 40 is at the second inner position Ci2, the clearance between the tray connection groove 48A and the transfer connecting unit 51A may be eliminated so that the tray unit 50 and the transfer unit 40 can be positioned relative to each other. In this case, the transfer unit 40 and the tray unit 50 can be accurately positioned relative to each other.

### Movement of Tray Unit and Transfer Unit

As shown in FIG. 1, FIG. 6, and FIG. 7, the tray unit 50 and the transfer unit 40 that are attached to the apparatus main body 1A are inclined with respect to the horizontal direction H.

More specifically, when the tray unit 50 is at the first inner position Ci1, the rotation axis of the photosensitive drum 61 closer to the first end 1b1 is positioned higher in the vertical direction V than the rotation axis of the photosensitive drum 61 farther from the first end 1b1.

That is, when the tray unit 50 is at the first inner position Ci1, the second photosensitive drum (the photosensitive drum 61 of the cartridge PC) is closer to the first end 1b1 than the first photosensitive drum (the photosensitive drum 61 of the cartridge PK) is to the first end 1b1. The rotation axis of the second photosensitive drum is positioned higher in the vertical direction V than the rotation axis of the first photosensitive drum. Similarly, the third photosensitive drum (the photosensitive drum 61 of the cartridge PM) is closer to the first end 1b1 than the second photosensitive drum is to the first end 1b1, and the rotation axis of the third photosensitive drum is positioned higher in the vertical direction V than the rotation axis of the second photosensitive drum. The fourth photosensitive drum (the photosensitive drum 61 of the cartridge PY) is closer to the first end 1b1 than the third photosensitive drum is to the first end 1b1, and the rotation axis of the fourth photosensitive drum is positioned higher in the vertical direction V than the rotation axis of the third photosensitive drum.

Here, a straight line connecting the centers of the photosensitive drums 61 is a straight-line LD. In Example 1, when the tray unit 50 is at the first inner position Ci1, the straight-line LD is inclined upward with respect to the horizontal direction H from the side farther from the first end 1b1 to the side closer to the first end 1b1.

In addition, the contact surface of the belt 41 that comes into contact with the first photosensitive drum, the second photosensitive drum, the third photosensitive drum, and the fourth photosensitive drum is inclined upward from the side farther from the first end 1b1 to the side closer to the first end 1b1.

When the tray unit 50 moves from the first inner position Ci1 to the first outer position Co1, the tray unit 50 moves in an inclined direction with respect to the horizontal direction H (in Example 1, a direction inclined upward with respect to the horizontal direction H). That is, when the tray unit 50 moves from the first inner position Ci1 to the first outer position Co1, the tray unit 50 moves obliquely upward.

When the tray unit 50 moves from the first inner position Ci1 to the first outer position Co1, the movement direction of the tray unit 50 changes from obliquely upward to downward. The movement direction of the tray unit 50 may include a direction parallel to the horizontal direction H or a direction obliquely downward with respect to the horizontal direction H.

The angle between the straight-line LD and the horizontal direction H is smaller when the tray unit 50 is at the first outer position Co1 than when the tray unit 50 is at the first inner position Ci1. In Example 1, when the tray unit 50 is at the first outer position Co1, the straight-line LD and the horizontal direction H are parallel to each other, but the straight-line LD may be inclined downward or upward with respect to the horizontal direction H.

Similarly, when the transfer unit 40 moves from the second inner position Ci2 to the second outer position Co2, the movement direction of the transfer unit 40 changes from obliquely upward to downward. The movement direction of the transfer unit 40 may include a direction parallel to the horizontal direction H or a direction obliquely downward with respect to the horizontal direction H.

The angle between the contact surface of the belt 41 and the horizontal direction H is smaller when the transfer unit 40 is at the second outer position Co2 than when the transfer unit 40 is at the second inner position Ci2. In Example 1, when the transfer unit 40 is at the second outer position Co2, the contact surface of the belt 41 is parallel to the horizontal direction H, but the contact surface of the belt 41 may be inclined downward or upward with respect to the horizontal direction H.

When the tray unit 50 moves from the first outer position Co1 to the first inner position Ci1, the tray unit 50 moves in the horizontal direction H and then moves obliquely downward along the way. When the transfer unit 40 moves from the second outer position Co2 to the second inner position Ci2, the transfer unit 40 moves in the horizontal direction H and then moves obliquely downward along the way. In such a configuration, when the tray unit 50 and the transfer unit 40 are inserted into the apparatus main body 1A, the own weights of the tray unit 50 and the transfer unit 40 can be used.

### Restriction Structure of Tray Unit

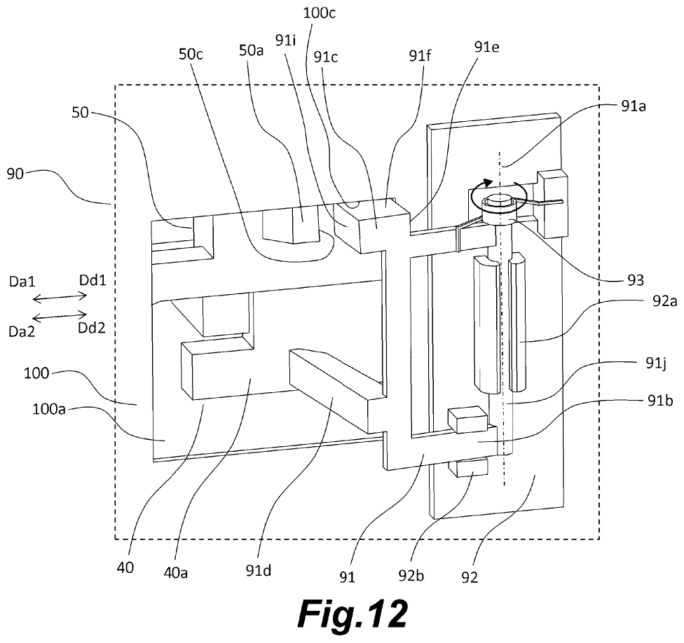

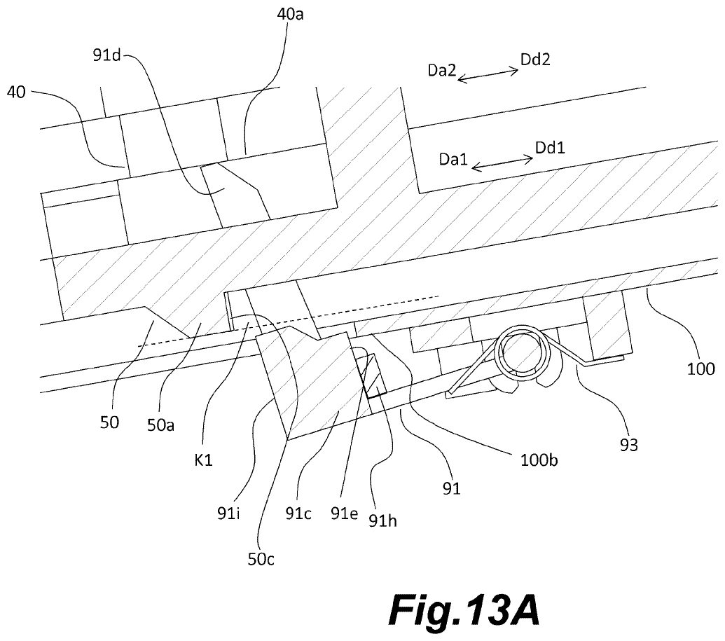

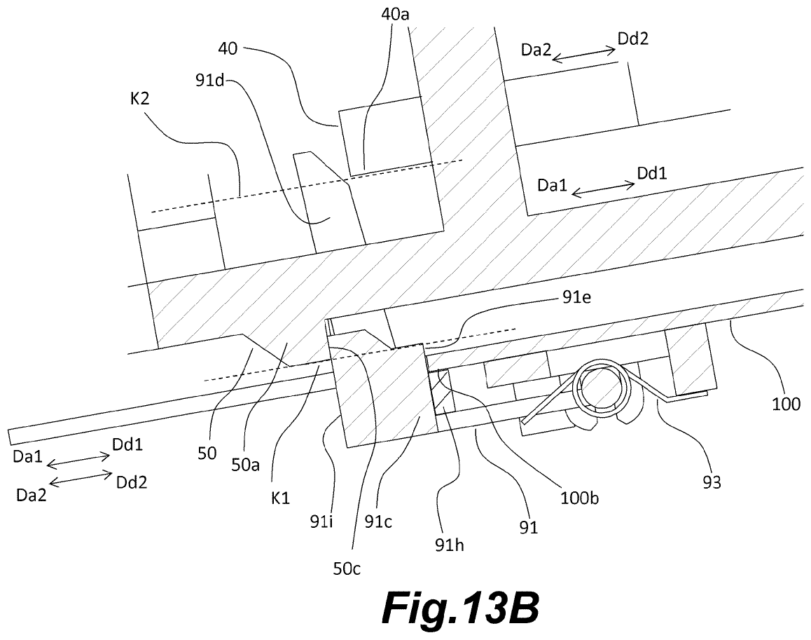

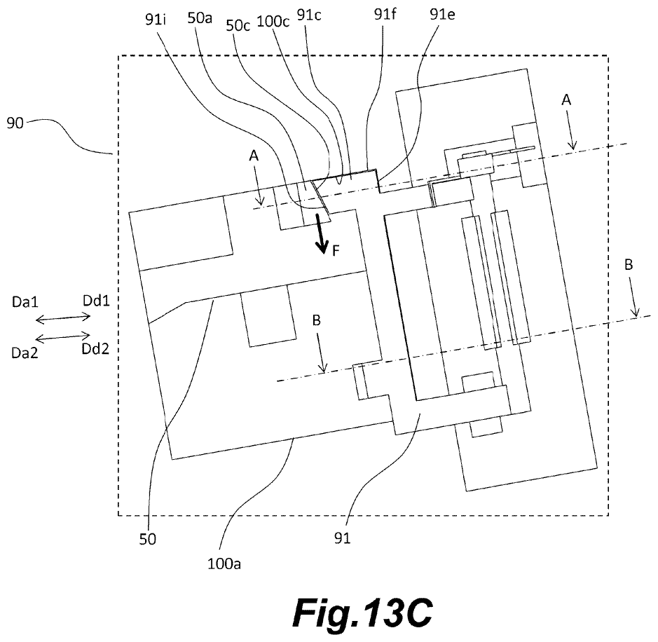

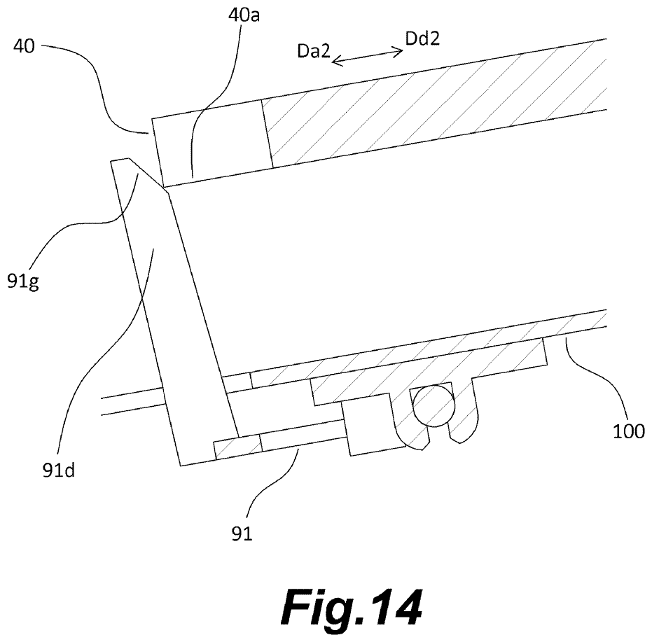

A restriction structure 90 in Example 1 in the present disclosure will be described with reference to FIG. 12, FIG. 13A to FIG. 13C, and FIG. 14. When the transfer unit 40 is drawn out from the apparatus main body 1A while the tray unit 50 is accommodated in the apparatus main body 1A, the restriction structure 90 restricts the tray unit 50 being drawn out from the apparatus main body 1A. As described above, since the tray unit 50 is supported by the door 20 via the transfer unit 40, if the tray unit 50 alone is drawn out to the first outer position Co1, supporting is not possible and a malfunction occurs. That is, when the transfer unit 40 is at the second outer position Co2, or when it is moving to the second outer position Co2, it is desirable that the tray unit 50 not be movable to the first outer position Co1. Under desired conditions, the restriction structure 90 for restricting the movement of the tray unit 50 is indicated by a dashed line in FIG. 5. FIG. 12, FIG. 13A to FIG. 13C, and FIG. 14 are diagrams showing the details of the restriction structure 90. FIG. 12 is a perspective view of the restriction structure 90. FIG. 13C is a side view of the restriction structure 90 (viewed in the rotation axis direction of the photosensitive drum 61). FIG. 13A and FIG. 13B are cross-sectional views taken along the line AA in FIG. 13C, and FIG. 14 is a cross-sectional view taken along the line BB in FIG. 13C.

As described above, the tray unit 50 is a first unit that is attached to the apparatus main body 1A. The transfer unit 40 is a second unit that is attached to the apparatus main body 1A, can be drawn out from the apparatus main body 1A together with the tray unit 50 and can be drawn out from the apparatus main body 1A while the tray unit 50 is accommodated in the apparatus main body 1A.

The tray unit 50 is supported by the transfer unit 40 during at least part of the process in which the tray unit 50 and the transfer unit 40 are drawn out together from the apparatus main body 1A. Since the transfer unit 40 is positioned below the tray unit 50, the tray unit 50 is supported from below by the transfer unit 40. The apparatus main body 1A has the opening 1A1, through which the tray unit 50 and the transfer unit 40 pass when the tray unit 50 and the transfer unit 40 are drawn out, and the door 20 that opens and closes the opening 1A1. During at least part of the process in which the tray unit 50 and the transfer unit 40 are drawn out together from the apparatus main body 1A, the transfer unit 40 is supported by the door 20 and the tray unit 50 is supported by the transfer unit 40. That is, the tray unit 50 is supported by the transfer unit 40 that is supported by the door 20.

In this manner, in Example 1, in the image forming apparatus in which a plurality of units can be drawn out from the apparatus main body, during at least part of the process of drawing out a plurality of units together, one unit supports another unit. Thereby, compared to a configuration in which each of the plurality of units is supported by a support member provided in the apparatus main body, the configuration of the support member of the apparatus main body can be simplified. On the other hand, as described above, in such a configuration, when one unit is drawn out from the apparatus main body, if an operation of drawing out another unit from the apparatus main body is performed, there is nothing to support the other unit. In Example 1, if the tray unit 50 is drawn out from the apparatus main body 1A when the transfer unit 40 is drawn out from the apparatus main body 1A, there is a timing at which the tray unit 50 is not supported by anything. This may cause problems such as a burden on the user who performs an operation of drawing out the tray unit 50 and the user dropping the tray unit 50.

Here, in Example 1, when the transfer unit 40 is drawn out from the apparatus main body 1A while the tray unit 50 is accommodated in the apparatus main body 1A, the restriction structure 90 for restricting the tray unit 50 being drawn out from the apparatus main body 1A is provided.

The restriction structure 90 includes an engagement portion and an engaged portion that is engageable with the engagement portion.

When the transfer unit 40 is at the attachment position (the second inner position Ci2) at which it is attached to the apparatus main body 1A, the engagement between the engagement portion and the engaged portion is released, and the tray unit 50 is allowed to be drawn out from the apparatus main body 1A. In this case, the tray unit 50 is allowed to be drawn out from the apparatus main body 1A together with the transfer unit 40.

When the transfer unit 40 is away from the attachment position (the second inner position Ci2) by a predetermined distance or more, the engagement portion and the engaged portion engage with each other, and the tray unit 50 being drawn out from the apparatus main body 1A is restricted.

In Example 1, the restriction structure 90 has a configuration in which a tray locking portion 50a, serving as an engagement portion provided in the tray unit 50, and a tray restriction unit 91c, serving as an engaged portion provided in the apparatus main body 1A, engage with each other.

The main frame 100 includes a restriction member 91. More specifically, the restriction member 91 is provided in the apparatus main body 1A. The tray restriction unit 91c serving as an engaged portion is provided in the restriction member 91. The restriction member 91 includes a shaft portion 91j and an arm portion 91b provided in the shaft portion 91j. A holding member 92 attached to the apparatus main body 1A of the main frame 100 includes a bearing 92a that rotatably supports the shaft portion 91j and a positioning unit 92b that determines the position of the arm portion 91b in the vertical direction. The restriction member 91 is a moving portion that can move by rotation between an allowance position at which the tray restriction unit 91c is separated from the tray locking portion 50a as shown in FIG. 13A and a restriction position at which the tray restriction unit 91c is engaged with the tray locking portion 50a as shown in FIG. 13B.

The restriction structure 90 includes a spring 93 serving as an applying portion (biasing part) that applies a force to the restriction member 91 that moves it to the restriction position (in a direction indicated by the arrow in FIG. 12, and a clockwise direction in FIG. 13A and FIG. 13B). The tray restriction unit 91c is provided in the upper part of the restriction member 91 and abuts against the tray locking portion 50a of the tray unit 50 to restrict the movement of the tray unit 50.

In addition, the restriction structure 90 has a transfer-side surface 40a, serving as a contact portion provided in the transfer unit 40, and a transfer protrusion 91d, serving as a contacted portion that is provided in the restriction member 91 and can come into contact with the transfer-side surface 40a. The transfer protrusion 91d is provided in the lower part of the restriction member 91. In the apparatus main body 1A of the main frame 100, a hole 100a through which the tray restriction unit 91c and the transfer protrusion 91d pass is provided.

As shown in FIG. 13A, when the transfer unit 40 is not drawn out from the apparatus main body 1A (when it is at the second inner position Ci2), the transfer-side surface 40a of the transfer unit 40 comes into contact with the transfer protrusion 91d of the restriction member 91. This is because, as shown in FIG. 13B, when the transfer unit 40 is drawn out, the transfer protrusion 91d is positioned inside the second space K2 serving as a space through which the transfer unit 40 passes when it is drawn out from the apparatus main body 1A. Here, when the transfer unit 40 is drawn out, the transfer unit 40 is away from the second inner position Ci2 by a predetermined distance or more.

Thereby, the restriction member 91 is pressed by the transfer unit 40 in a direction against the force of the spring 93 and is positioned at the allowance position. When the restriction member 91 is at the allowance position, the tray restriction unit 91c is positioned outside the first space K1 (indicated by a dashed line in FIG. 13A) through which the tray unit 50 passes when it is drawn out from the apparatus main body 1A. Therefore, the tray unit 50 can move between the first inner position Ci1 and the first outer position Co1 without being restricted in its movement from the attachment position.

As shown in FIG. 13B, when the transfer unit 40 is drawn out from the apparatus main body 1A while the tray unit 50 is accommodated in the apparatus main body 1A, the transfer-side surface 40a of the transfer unit 40 moves and is no longer in contact with the transfer protrusion 91d of the restriction member 91. Thereby, the restriction member 91 rotates clockwise in FIG. 13B due to the force of the spring 93 and moves to a position at which a frame abutting part 91h abuts against the main frame 100. In this case, the transfer protrusion 91d is positioned inside the second space K2 serving as a space through which the transfer unit 40 passes when it is drawn out from the apparatus main body 1A. In addition, the tray restriction unit 91c is positioned inside the first space K1. More specifically, the tray restriction unit 91c is positioned downstream from the tray locking portion 50a in a drawing-out direction (tray removal direction) Dd1 of the tray unit 50. In this state, when the tray unit 50 moves in the tray removal direction Dd1, the tray locking portion 50a comes into contact with the tray restriction unit 91c. Therefore, the tray unit 50 cannot move in the tray removal direction Dd1. In this case, as shown in FIG. 13B, when viewed in the rotation axis direction of the restriction member 91, the tray restriction unit 91c is closer to the tray unit 50 than the rotation axis of the restriction member 91 is to the tray unit 50. Therefore, when the tray restriction unit 91c receives a force from the tray locking portion 50a, the tray restriction unit 91c is prevented from being disengaged from the tray locking portion 50a.

In this manner, the restriction member 91 is positioned at the allowance position when the tray unit 50 and the transfer unit 40 are attached to the apparatus main body 1A, and is positioned at the restriction position when the transfer unit 40 is drawn out from the apparatus main body 1A. Then, when the transfer unit 40 is drawn out from the apparatus main body 1A while the tray unit 50 is accommodated in the apparatus main body 1A, the restriction member 91 moves from the allowance position to the restriction position. In this example, the restriction member 91 moves from the allowance position to the restriction position due to a force of the spring 93, but the restriction member 91 may be disposed so that the restriction member 91 moves from the allowance position to the restriction position by its own weight.

If the user performs an operation of drawing out the tray unit 50 when the restriction member 91 is at the restriction position, the tray restriction unit 91c may receive a force from the tray locking portion 50a in the tray removal direction Dd1. If this force is received only by the restriction member 91 or the holding member 92, a load is applied to the restriction member 91 or the holding member 92.

In Example 1, as shown in FIG. 13B, a surface 91i that comes into contact with the tray locking portion 50a of the tray restriction unit 91c, and an opposite surface 91e, which is on the opposite side in the tray removal direction Dd1, abut against an end 100b for the hole 100a in the tray removal direction Dd1.

In addition, as shown in FIG. 13C, an abutment surface 50c of the tray locking portion 50a that abuts against the surface 91i of the tray restriction unit 91c is formed as an inclined surface. This inclined surface is formed such that, if a force is applied to the tray unit 50 in the tray removal direction Dd1 when the surface 91i comes into contact with the abutment surface 50c, a force is applied to push the tray unit 50 downward (in a direction indicated by an arrow F).

With the above configuration, when a force is applied to the tray unit 50 in the tray removal direction Dd1, an upper surface 91f of the tray restriction unit 91c abuts against an end 100c of the hole 100a in the main frame 100. The end 100c is an end in a direction perpendicular to the tray removal direction Dd1 and the rotation axis direction of the photosensitive drum 61, and is an upward end. Therefore, since the force for drawing out the tray unit 50 is received by the main frame 100, it is possible to reduce a load on the restriction member 91 and the holding member 92, and it is possible to prevent deformation or damage from occurring. Thereby, it is possible to more reliably restrict the movement of the tray unit 50.

As shown in FIG. 14, when the tray unit 50 moves from the first outer position Co1 to the first inner position Ci1, the tip of the transfer-side surface 40a comes into contact with an inclined surface 91g connected to the transfer protrusion 91d, and the restriction member 91 rotates counterclockwise and retracts. Therefore, the restriction member 91 does not hinder the movement of the tray unit 50 in the attachment direction. In addition, when the transfer unit 40 moves from the second outer position Co2 to the second inner position Ci2, the tip of the transfer-side surface 40a comes into contact with the inclined surface 91g, and the restriction member 91 rotates and retracts. Therefore, the restriction member 91 does not hinder the movement of the transfer unit 40 in the attachment direction.

As described above, according to Example 1, when the transfer unit 40 is drawn out from the apparatus main body 1A while the tray unit 50 is accommodated in the apparatus main body 1A, the tray unit 50 being drawn out from the apparatus main body 1A is restricted. That is, when the transfer unit 40 is at the second outer position Co2 or when it is moving to the second outer position Co2 (when it is away from the second inner position Ci2 by a predetermined distance or more), the tray unit 50 cannot move to the first outer position Co1. In an image forming apparatus in which the tray unit 50 is supported by the transfer unit 40 during at least part of the process in which the tray unit 50 and the transfer unit 40 are drawn out together from the apparatus main body 1A, problems caused by the tray unit 50 being drawn out alone can be avoided.

Here, in Example 1, an example in which the restriction member 91 is movable between the restriction position and the allowance position by a rotational movement is shown, but the restriction member 91 is movable between the restriction position and the allowance position by a linear movement. For example, in FIG. 13A and FIG. 13B, the holding member 92 is configured to support the restriction member 91 so that it is movable in a direction perpendicular to the main frame 100. Then, a spring for applying a force to the restriction member 91 in a direction perpendicular to the main frame 100 and a direction toward the transfer unit 40 may be provided in the main frame 100. When the transfer unit 40 is at the second inner position Ci2, the restriction member 91 is pushed in by the transfer unit 40 against the force of the spring, and the tray restriction unit 91c moves to a position at which it is not engaged with the tray locking portion 50a outside the first space K1. This allows the tray unit 50 to be drawn out. In addition, when the transfer unit 40 is away from the second inner position Ci2 by a predetermined distance or more, the restriction member 91 moves into the second space K2 due to the force of the spring, and the tray restriction unit 91c moves to a position at which it engages with the tray locking portion 50a inside the first space K1. This restricts the tray unit 50 being drawn out.

### Modification Example

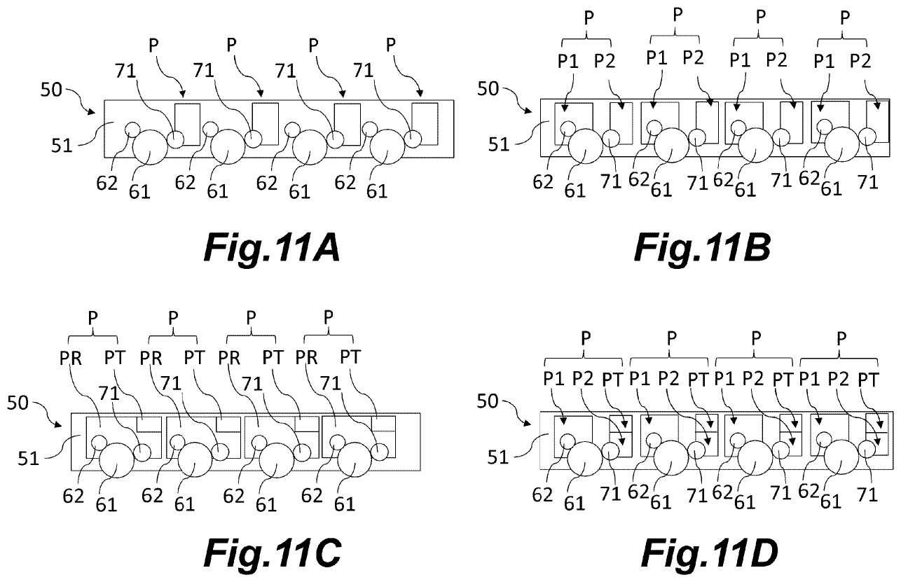

As described above, the photosensitive drum 61, the charging roller 62, and the developing roller 71 may be provided in either the cartridge P or the tray 51. This will be described with reference to FIG. 11A to FIG. 11D. FIG. 11A to FIG. 11D are diagrams showing the tray unit 50 according to a modification example.

For example, as shown in FIG. 11A, the tray 51 may include the photosensitive drum 61 and the charging roller 62, and the cartridge P may include the developing roller 71.

As shown in FIG. 11B, the cartridge P may include the photosensitive drum 61, a drum cartridge P1 including the charging roller 62, and a developing cartridge P2 including the developing roller 71. That is, the cartridge P can be separated into the drum cartridge P1 and the developing cartridge P2. In this case, it is preferable that the drum cartridge P1 and the developing cartridge P2 be independently detachable from the tray 51.

In addition, as shown in FIG. 11C, the cartridge P may include the photosensitive drum 61, the charging roller 62, a process cartridge PR including the developing roller 71, and a toner cartridge PT including a toner for replenishing the process cartridge PR. That is, the cartridge P can be separated into the process cartridge PR and the toner cartridge PT.

In addition, as shown in FIG. 11D, the cartridge P may include the drum cartridge P1, the developing cartridge P2, and the toner cartridge PT. The drum cartridge P1 includes the photosensitive drum 61 and the charging roller 62. The developing cartridge P2 includes the developing roller 71. The toner cartridge PT includes a toner for replenishing the developing cartridge P2. That is, the cartridge P can be separated into the drum cartridge P1, the developing cartridge P2, and the toner cartridge PT.

In Example 1, the tray unit 50 is an image forming unit including the detachable cartridge P including the photosensitive drum 61, the charging roller 62, and the developing roller 71, but the configuration of the tray unit 50 is not limited thereto. For example, the tray unit 50 may include a detachable toner cartridge having a toner container for accommodating a toner.

### Example 2

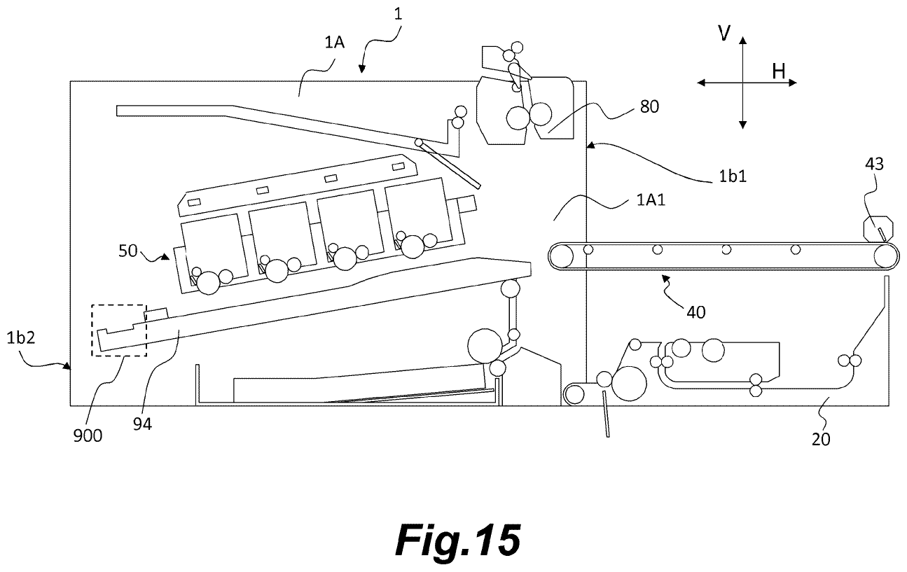

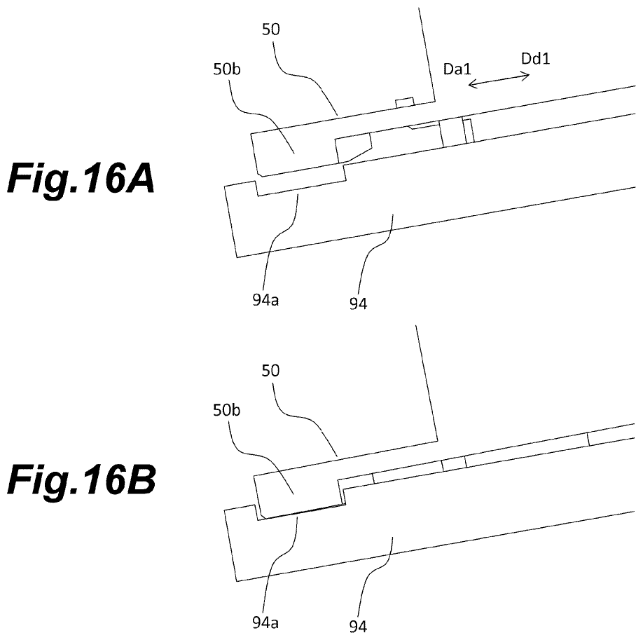

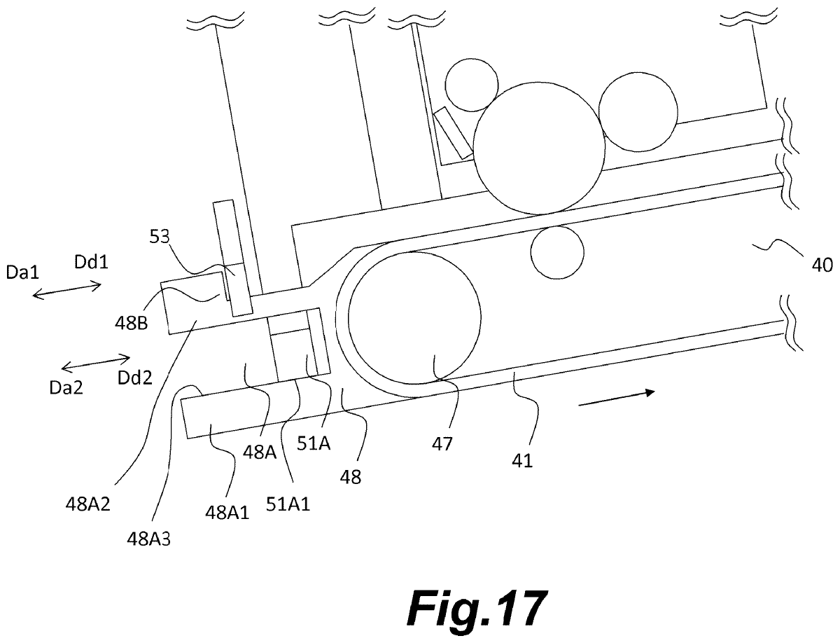

Example 2 of the present disclosure will be described with reference to FIG. 15, FIG. 16A, FIG. 16B, and FIG. 17. Example 2 differs from Example 1 in a restriction structure that restricts the tray unit 50 being drawn out from the apparatus main body 1A when the transfer unit 40 is drawn out from the apparatus main body 1A while the tray unit 50 is accommodated in the apparatus main body 1A. A restriction structure 900 in Example 2 is provided in the portion indicated by the dashed line in FIG. 15, and FIG. 16A, FIG. 16B, and FIG. 17 are diagrams showing the details thereof.

In Example 2, when the tray unit 50 is accommodated in the apparatus main body 1A, it is movable between a first accommodation position shown in FIG. 16A and a second accommodation position shown in FIG. 16B.

When the transfer unit 40 is attached to the apparatus main body 1A, the tray unit 50 is supported by the transfer unit 40 and positioned at the first accommodation position. In this case, the transfer unit 40 is supported by a tray guide 94 provided in the apparatus main body 1A. Therefore, it can be said that the tray unit 50 is supported by the apparatus main body 1A via the transfer unit 40.

When the transfer unit 40 is attached to the apparatus main body 1A, the tray unit 50 is positioned above the transfer unit 40 in the vertical direction. Therefore, when the tray unit 50 is supported by the transfer unit 40, as shown in FIG. 17, the transfer connecting unit 51A rests, between a downward arm portion 48A1 and an upward arm portion 48A2 that constitute the tray connection groove 48A, on the downward arm portion 48A1. Therefore, a lower surface 51A1 of the transfer connecting unit 51A comes into contact with an upper surface 48A3 of the downward arm portion 48A1.

When the transfer unit 40 is drawn out from the apparatus main body 1A, the tray unit 50 is supported by the tray guide 94 provided in the apparatus main body 1A and is positioned at the second accommodation position. Therefore, it can be said that the tray unit 50 is supported by the apparatus main body 1A. A case in which the transfer unit 40 is drawn out from the apparatus main body 1A is a case in which the transfer unit 40 is at the second outer position Co2 or a case in which the transfer unit 40 is moving to the second outer position Co2. The case in which the transfer unit 40 is moving to the second outer position Co2 is a case in which the transfer unit 40 is away from the second inner position Ci2, which is the attachment position, by a predetermined distance or more.

When the transfer unit 40 is drawn out from the apparatus main body 1A while the tray unit 50 is accommodated in the apparatus main body 1A, the tray unit 50 moves from the first accommodation position to the second accommodation position. In Example 2, the second accommodation position is lower than the first accommodation position in the vertical direction. Therefore, when the transfer unit 40 is drawn out from the apparatus main body 1A while the tray unit 50 is accommodated in the apparatus main body 1A, the tray unit 50 moves down due to its own weight and moves from the first accommodation position to the second accommodation position.

When the transfer unit 40 moves from the second inner position Ci2 to the second outer position Co2, or when it moves in the opposite direction while the tray unit 50 is accommodated in the apparatus main body 1A, the lower surface of the transfer unit 40 moves while supported by the tray guide 94. Similarly, when the tray unit 50 is drawn out from the apparatus main body 1A together with the transfer unit 40, the lower surface of the transfer unit 40 moves while supported by the tray guide 94. In this case, the tray unit 50 moves from the first inner position Ci1 to the first outer position Co1 or in the opposite direction, together with the transfer unit 40, while supported by the transfer unit 40.

On the lower surface on the side closer to the second end 1b2 of the tray unit 50, a protruded portion 50b serving as an engagement portion is provided. In the tray guide 94, a concave portion 94a serving as an engaged portion is provided at a position facing the protruded portion 50b of the tray unit 50 when the tray unit 50 is at the first accommodation position.

When the tray unit 50 is at the first accommodation position, as shown in FIG. 16A, the protruded portion 50b serving as an engagement portion is separated from the concave portion 94a serving as an engaged portion, and the engagement between the protruded portion 50b and the concave portion 94a is released. When the engagement between the protruded portion 50b and the concave portion 94a is released, the tray unit 50 is allowed to be drawn out from the apparatus main body 1A.

When the tray unit 50 is at the second accommodation position, as shown in FIG. 16B, the protruded portion 50b is engaged with the concave portion 94a. When the protruded portion 50b and the concave portion 94a are engaged with each other, the tray unit 50 being drawn out from the apparatus main body 1A is restricted.

When the transfer unit 40 is at the second inner position Ci2, which is an attachment position at which the transfer unit 40 is attached to the apparatus main body 1A, the tray unit 50 is at the first accommodation position, and the engagement between the protruded portion 50b and the concave portion 94a is released. When the engagement between the protruded portion 50b and the concave portion 94a is released, the tray unit 50 is allowed to be drawn out from the apparatus main body 1A together with the transfer unit 40.

When the transfer unit 40 is drawn out from the apparatus main body 1A, the tray unit 50 moves to the second accommodation position, and the protruded portion 50b and the concave portion 94a engage with each other. Thereby, when the transfer unit 40 is drawn out from the apparatus main body 1A while the tray unit 50 is accommodated in the apparatus main body 1A, the tray unit 50 being drawn out from the apparatus main body 1A is restricted.

According to the present disclosure, it is possible to further develop an image forming apparatus in which a plurality of units can be drawn out from the apparatus main body.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-037975, which was filed on Mar. 12, 2024 and which is hereby incorporated by reference herein in its entirety.

What is claimed is:

1. An image forming apparatus, comprising:
an apparatus main body;
a first unit configured to be attached to the apparatus main body;
a second unit configured to be attached to the apparatus main body, the second unit being configured (1) to be drawn out from the apparatus main body together with the first unit and (2) to be drawn out from the apparatus main body while the first unit is accommodated in the apparatus main body; and
a restriction structure configured to restrict the first unit from being drawn out from the apparatus main body in a case where the second unit is drawn out from the apparatus main body while the first unit is accommodated in the apparatus main body,
wherein during at least part of a process in which the first unit and the second unit are drawn out together from the apparatus main body, the second unit supports the first unit.

2. The image forming apparatus according to claim 1, wherein the second unit is positioned below the first unit.

3. The image forming apparatus according to claim 1,
wherein the apparatus main body includes:
an opening through which the first unit and the second unit pass when the first unit and the second unit are drawn out; and
a door configured to open and close the opening, and
wherein the door supports the second unit and the first unit is supported by the second unit that is supported by the door during at least part of the process in which the first unit and the second unit are drawn out together from the apparatus main body.

4. The image forming apparatus according to claim 1,
wherein the restriction structure includes:
an engagement portion; and
an engaged portion configured to be engaged with the engagement portion,
wherein the first unit can be drawn out from the apparatus main body in a state where the engagement portion and the engaged portion are not engaged with each other, and
wherein the first unit is restricted from being drawn out from the apparatus main body in a state where the engagement portion and the engaged portion are engaged with each other.

5. The image forming apparatus according to claim 4,
wherein the engagement portion and the engaged portion are not engaged with each other in a state where the second unit is at an attachment position at which the second unit is attached to the apparatus main body, and
wherein the engagement portion and the engaged portion are engaged with each other in a case where the second unit is away from the attachment position.

6. The image forming apparatus according to claim 5, wherein the first unit can be drawn out from the apparatus main body together with the second unit in a state where the engagement portion and the engaged portion are not engaged with each other.

7. The image forming apparatus according to claim 4,
wherein the restriction structure includes a moving portion provided in the apparatus main body and including the engaged portion, the moving portion being configured to move between an allowance position at which the engaged portion is separated from the engagement portion and a restriction position at which the engaged portion is engaged with the engagement portion,
wherein the moving portion is positioned at the allowance position in a state where the first unit and the second unit are attached to the apparatus main body,
wherein the moving portion is positioned at the restriction position in a state where the second unit is drawn out from the apparatus main body, and
wherein the moving portion moves from the allowance position to the restriction position in a case where the second unit is drawn out from the apparatus main body while the first unit is accommodated in the apparatus main body.

8. The image forming apparatus according to claim 7,
wherein the restriction structure includes:
a contact portion provided in the second unit;
a contacted portion provided in the moving portion and configured to come into contact with the contact portion; and
an applying portion applying to the moving portion a force in a direction toward the restriction position,
wherein the moving portion is positioned at the allowance position by being pressed by the second unit in a direction against the force of the applying portion with the contact portion of the second unit coming into contact with the contacted portion of the moving portion in a case where the second unit is not drawn out from the apparatus main body, and
wherein the moving portion moves to the restriction position by the force of the applying portion in a case where the second unit is drawn out from the apparatus main body while the first unit is accommodated in the apparatus main body.

9. The image forming apparatus according to claim 7,
wherein the restriction structure includes:
a contact portion provided in the second unit;
a contacted portion provided in the moving portion and configured to come into contact with the contact portion; and
an applying portion applying to the moving portion a force in a direction toward the restriction position,
wherein in a case where the moving portion is at the allowance position,
the engaged portion is positioned outside a first space through which the first unit passes when being drawn out from the apparatus main body, and
the contacted portion comes into contact with the contact portion of the second unit, and
wherein in a case where the moving portion is at the restriction position,
the engaged portion comes into contact with the engagement portion at a position that is inside the first space and is located in a direction in which the first unit is drawn out relative to the engagement portion, and
the contacted portion is positioned inside a second space through which the second unit passes when being drawn out from the apparatus main body.

10. The image forming apparatus according to claim 4,
wherein in a state where the first unit is accommodated in the apparatus main body,
the first unit is positioned at a first accommodation position at which the engagement portion provided in the first unit is separated from the engaged portion in a case where the second unit is attached to the apparatus main body,
the first unit is positioned at a second accommodation position at which the engagement portion is engaged with the engaged portion in a case where the second unit is drawn out from the apparatus main body, and
wherein the first unit moves from the first accommodation position to the second accommodation position in a case where the second unit is drawn out from the apparatus main body while the first unit is accommodated in the apparatus main body.

11. The image forming apparatus according to claim 10,
wherein the second accommodation position is lower than the first accommodation position in a vertical direction,
wherein in a state where the first unit is accommodated in the apparatus main body,
the first unit is at the first accommodation position by being supported by the second unit in a case where the second unit is attached to the apparatus main body, and
the first unit is at the second accommodation position by being supported by the apparatus main body in a case where the second unit is drawn out from the apparatus main body, and
wherein the first unit moves down by a weight thereof and moves from the first accommodation position to the second accommodation position in a case where the second unit is drawn out from the apparatus main body while the first unit is accommodated in the apparatus main body.

12. The image forming apparatus according to claim 1,
wherein the apparatus main body includes a fixing unit configured to fix a toner image transferred onto a recording material, the fixing unit being configured to move between a use position at which a fixing operation is performed and a retraction position retracted from the use position,
wherein, in a case where the fixing unit is located at the use position, at least a portion of the fixing unit is positioned inside at least one of a first space and a second space, the first space being a space through which the first unit passes when being drawn out from the apparatus main body and the second space being a space through which the second unit passes when being drawn out from the apparatus main body, and
wherein, in a case where the fixing unit is located at the retraction position, the fixing unit is positioned outside the first space and the second space.

13. The image forming apparatus according to claim 1,
wherein the first unit is an image forming unit including:
a photosensitive drum; and
a developing unit configured to form a toner image on a surface of the photosensitive drum, and
wherein the second unit is a belt unit having a belt configured to come into contact with the photosensitive drum.

14. The image forming apparatus according to claim 13,
wherein the first unit includes a cartridge detachable from the first unit, and
wherein the developing unit is included in the cartridge.

15. An image forming apparatus, comprising:
an apparatus main body;
a first unit configured to be attached to the apparatus main body;
a second unit configured to be attached to the apparatus main body, the second unit being configured (1) to be drawn out from the apparatus main body together with the first unit, and (2) to be drawn out from the apparatus main body while the first unit is accommodated in the apparatus main body; and
a restriction structure configured to restrict the first unit from being drawn out from the apparatus main body in a case where the second unit is drawn out from the apparatus main body while the first unit is accommodated in the apparatus main body,
wherein the first unit is an image forming unit including:
a photosensitive drum; and
a developing unit configured to form a toner image on a surface of the photosensitive drum, and
wherein the second unit is a belt unit having a belt configured to come into contact with the photosensitive drum.

16. The image forming apparatus according to claim 15, wherein the second unit is positioned below the first unit.

17. The image forming apparatus according to claim 15,
wherein the apparatus main body includes:
an opening through which the first unit and the second unit pass when the first unit and the second unit are drawn out; and
a door configured to open and close the opening, and
wherein the door supports the second unit and the first unit is supported by the second unit that is supported by the door during at least part of a process in which the first unit and the second unit are drawn out together from the apparatus main body.

18. The image forming apparatus according to claim 15,
wherein the restriction structure includes:
an engagement portion; and
an engaged portion configured to be engaged with the engagement portion,
wherein the first unit can be drawn out from the apparatus main body in a state where the engagement portion and the engaged portion are not engaged with each other, and
wherein the first unit is restricted from being drawn out from the apparatus main body in a state where the engagement portion and the engaged portion are engaged with each other.

19. The image forming apparatus according to claim 18,
wherein the engagement portion and the engaged portion are not engaged with each other in a state where the second unit is at an attachment position at which the second unit is attached to the apparatus main body, and
wherein the engagement portion and the engaged portion are engaged with each other in a case where the second unit is away from the attachment position.

20. The image forming apparatus according to claim 19, wherein the first unit can be drawn out from the apparatus main body together with the second unit in a state where the engagement portion and the engaged portion are not engaged with each other.

21. The image forming apparatus according to claim 18,
wherein the restriction structure includes a moving portion provided in the apparatus main body and including the engaged portion, the moving portion being configured to move between an allowance position at which the engaged portion is separated from the engagement portion and a restriction position at which the engaged portion is engaged with the engagement portion,
wherein the moving portion is positioned at the allowance position in a state where the first unit and the second unit are attached to the apparatus main body,
wherein the moving portion is positioned at the restriction position in a state where the second unit is drawn out from the apparatus main body, and
wherein the moving portion moves from the allowance position to the restriction position in a case where the second unit is drawn out from the apparatus main body while the first unit is accommodated in the apparatus main body.

22. The image forming apparatus according to claim 21,
wherein the restriction structure includes:
a contact portion provided in the second unit;
a contacted portion provided in the moving portion and configured to come into contact with the contact portion; and
an applying portion applying to the moving portion a force in a direction toward the restriction position,
wherein the moving portion is positioned at the allowance position by being pressed by the second unit in a direction against the force of the applying portion with the contact portion of the second unit coming into contact with the contacted portion of the moving portion in a case where the second unit is not drawn out from the apparatus main body, and
wherein the moving portion moves to the restriction position by the force of the applying portion in a case where the second unit is drawn out from the apparatus main body while the first unit is accommodated in the apparatus main body.

23. The image forming apparatus according to claim 21,
wherein the restriction structure includes:
a contact portion provided in the second unit;
a contacted portion provided in the moving portion and configured to come into contact with the contact portion; and
an applying portion applying to the moving portion a force in a direction toward the restriction position,
wherein in a case where the moving portion is at the allowance position,
the engaged portion is positioned outside a first space through which the first unit passes when being drawn out from the apparatus main body, and
the contacted portion comes into contact with the contact portion of the second unit, and
wherein in a case where the moving portion is at the restriction position,
the engaged portion comes into contact with the engagement portion at a position that is inside the first space and is located in a direction in which the first unit is drawn out relative to the engagement portion, and
the contacted portion is positioned inside a second space through which the second unit passes when being drawn out from the apparatus main body.

24. The image forming apparatus according to claim 18,
wherein in a state where the first unit is accommodated in the apparatus main body,
the first unit is positioned at a first accommodation position at which the engagement portion provided in the first unit is separated from the engaged portion in a case where the second unit is attached to the apparatus main body,
the first unit is positioned at a second accommodation position at which the engagement portion is engaged with the engaged portion in a case where the second unit is drawn out from the apparatus main body, and
wherein the first unit moves from the first accommodation position to the second accommodation position in a case where the second unit is drawn out from the apparatus main body while the first unit is accommodated in the apparatus main body.

25. The image forming apparatus according to claim 24,
wherein the second accommodation position is lower than the first accommodation position in a vertical direction,
wherein in a state where the first unit is accommodated in the apparatus main body,
the first unit is at the first accommodation position by being supported by the second unit in a case where the second unit is attached to the apparatus main body,
the first unit is at the second accommodation position by being supported by the apparatus main body in a case where the second unit is drawn out from the apparatus main body, and
wherein the first unit moves down by a weight thereof and moves from the first accommodation position to the second accommodation position in a case where the second unit is drawn out from the apparatus main body while the first unit is accommodated in the apparatus main body.

26. The image forming apparatus according to claim 15,
wherein the apparatus main body includes a fixing unit configured to fix a toner image transferred onto a recording material, the fixing unit being configured to move between a use position at which a fixing operation is performed and a retraction position retracted from the use position,
wherein, in a case where the fixing unit is located at the use position, at least a portion of the fixing unit is positioned inside at least one of a first space and a second space, the first space being a space through which the first unit passes when being drawn out from the apparatus main body and the second space being a space through which the second unit passes when being drawn out from the apparatus main body, and
wherein, in a case where the fixing unit is located at the retraction position, the fixing unit is positioned outside the first space and the second space.

27. The image forming apparatus according to claim 15,
wherein the first unit includes a cartridge detachable from the first unit, and
wherein the developing unit is included in the cartridge.
